(19) United States
(12) Patent Application Publication
(10) Pub. No.: US 2009/0216611 A1
(43) Pub. Date: Aug. 27, 2009

(54) Computer-Implemented Systems And Methods Of Product Forecasting For New Products

(76) Inventors: Michael J. Leonard, Cary, NC (US); Thomas H. Dickey, Cary, NC (US); Samuel Lawrence Guseman, Austin, TX (US); Michele Angelo Trovero, Dunellen, NJ (US)

Correspondence Address: PATENT GROUP 2N;JONES DAY, NORTH POINT, 901 LAKESIDE AVENUE, CLEVELAND, OH, 44114, US

(21) Appl. No.: 12/036,782

(22) Filed: Feb. 25, 2008

(51) Int. Cl. G06Q 10/00

(52) U.S. Cl. 705/10

(57) ABSTRACT

Computer-implemented systems and methods are provided for forecasting the performance of products newly introduced to a market. For example, a business that seeks to introduce a new product onto the market may query the data maintained by the business about the results of previous introductions of new products. Further, the computer-implemented systems and methods, with or without the intervention of a human expert, may assess which of the historical products are most similar to the new product that the business seeks to introduce, and thus may use the most similar product as the basis for forming a product forecast for the product that is to be newly introduced.

### TECHNICAL FIELD

The technology described in this patent document relates generally to product forecasting, and more specifically to systems and methods of product forecasting for the performance of a new product or products to be introduced into a market.

### BACKGROUND

Forecasting the performance of a product newly introduced to a market is a difficult problem, as one of the most useful tools for creating product forecasts, namely historical sales data, is by definition absent when a product is newly introduced to a market. The introduction of a new product to a market, though, often requires a large capital outlay prior to the introduction of the new product. Given the large capital investment that may be at stake, businesses that seek to introduce new products have a significant need for methods and systems that can produce forecasts for the new products, thereby allowing the businesses to make better decisions regarding the introduction of the new products.

### SUMMARY

In accordance with the teachings herein, computer-implemented systems and methods are provided for forecasting the performance of products newly introduced into the marketplace. For example, a business that seeks to introduce a new product into the marketplace may query the data maintained by the business about the results of previous introductions of new products. Further, the computer-implemented systems and methods may assess which of the historical products are most similar to the new product that the business seeks to introduce, and thus may use the most similar product as the basis for forming a product forecast for the product that is to be newly introduced. Accordingly, similarity techniques may be used to limit the potentially large amount of historical market data to those data sets that correspond to the product launches most likely to be helpful in generating a forecast for the new product. The market performance data associated with the products identified as being the most similar then are used to create a forecast of the performance of the new product when it is introduced into the marketplace.

In another example, the computer-implemented systems and methods taught herein are supplemented by the guidance of a human expert, who makes use of the graphical user interfaces disclosed herein to ensure that the data chosen according to these systems and methods are appropriate for the new product to be introduced. In still another example, the teachings herein permit capturing the analysis performed by the human expert and reducing the analysis to computer-executable instructions, so that non-expert users and/or the computer-implemented systems and methods themselves may make use of the expert's analytical methods in analyses of other products.

### BRIEF DESCRIPTION OF THE DRAWINGS

FIG. 1 is a block diagram depicting an environment wherein users can interact with a new product forecasting system.

FIG. 2A is a block diagram illustrating an example system and method for forecasting the performance of a new product.

FIG. 2B is a block diagram illustrating analytic and judgmental steps performed in an example system and method for forecasting the performance of a new product.

FIG. 3 is a block diagram illustrating further detail of the process of structured judgment analysis.

FIG. 4 is a block diagram illustrating further detail of the process of combining statistics and judgment in an example system and method for forecasting the performance of a new product.

FIGS. 5A-5E are graphs showing various representations for visualizing collected and derived historical market performance series data for a previously introduced product.

FIG. 6 is a block diagram illustrating an example method of deriving historical market performance data from collected historical market performance data.

FIG. 7 is a block diagram depicting further detail of the query step of an example method for forecasting the performance of a new product.

FIG. 8 is a dendrogram depicting information contained in the distance matrix of a cluster of historical market performance series data.

FIGS. 9A and 9B are graphs depicting cycle series data for different clusters generated from historical market performance series data.

FIG. 10 is a block diagram depicting additional details of the filter step of an example method for forecasting the performance of a new product.

FIG. 11 is a graph depicting the predictions derived from a panel summary model.

FIG. 12 is a graph depicting the predictions derived from a profile series model.

FIG. 13 is a graph depicting the predictions derived from a cycle series model.

FIG. 14 is a block diagram depicting additional details of the model step of an example method for forecasting the performance of a new product.

FIG. 15 is a block diagram depicting additional details of the forecast step of an example method for forecasting the performance of a new product.

FIG. 16 is a block diagram depicting details about the overrides sub-step in a forecast step of an example method for forecasting the performance of a new product.

FIG. 17 is a block diagram depicting a single general purpose computer environment wherein a user can interact with a new product forecasting system.

### DETAILED DESCRIPTION

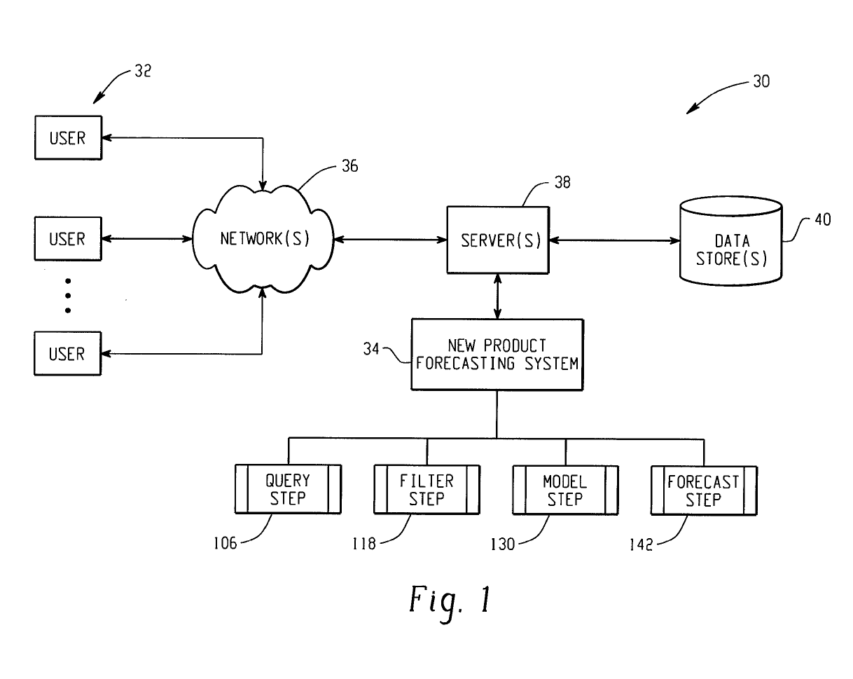

FIG. 1 depicts at 30 an environment wherein users 32 can interact with a forecasting system 34 that is configured to provide forecasts for new products. The users 32 can interact with the new product forecasting system 34 through a number of ways, such as over one or more networks 36. Server(s) 38 accessible through the network(s) 36 can host the system 34, and one or more data stores 40 can store the data to be analyzed by the system 34 as well as any intermediate or final data generated by the system 34.

The system 34 allows for forecasting the performance of a product that will be introduced into the marketplace. The forecasting by system 34 is based on a statistical model or models that are derived from a set of historical market performance data for products previously introduced to the marketplace. To help accomplish the forecasting based upon a set historical market performance data, the forecasting system 34 uses a series of steps to help obtain, refine, and ultimately utilize the historical data and/or a derivation thereof to provide performance forecasts for a new product. In one embodiment, the series of steps can include a query step 106, filter step 118, model step 130, and forecast step 142, wherein each step further can include both analytical substeps and judgmental substeps.

For example, a query step 106 can allow a user to specify attributes of a new product that will be used to identify those products that have been previously introduced to the marketplace and which are most similar to the new product. The analytical substeps of the query step 106 may involve the application of a defined query to the historical data set that generates a subset of performance data for a group of products ostensibly similar to the new product. The judgment substeps of the query step 106 then may involve the user, or a proxy for the user, such as stored decision programs encapsulating the user's decision processes, exploring the results produced in the analytical substeps and further refining, through addition or removal of performance data, the subset of the historical data set.

In a filter step 118, the user can specify a statistical filtering methodology to be applied to the subset of the historical data set. Examples of such methodologies may include clustering methods, reduction transformations, and distance measures. The analytical substeps of the filter step 118 again can involve the automated application of the user-produced specification to the input data (in this example, the subset of the historical data set), which generates a surrogate data set. The judgmental substeps of the filter step 118 than may involve the user, or the user's proxy, exploring the surrogate data set and further refining the data contained therein.

In a model step 130, the user can specify an analytical input, for example a model specification, which identifies one or more modeling techniques the user wishes to be carried out in the analytical substeps of the model step 130. Examples of such modeling techniques may include growth curves, neural networks, and diffusion models. The application of the model specification to the surrogate data series results in a model data set. In the judgmental substeps of the model step 130, the user, or the user's proxy, may explore the output of the analytical substeps in order to refine the composition of the model data set.

In a forecast step 142, the user can generate a forecast specification, which describes the timing of the release of the new product. The forecast specification then may be used in the analytical substeps to adjust the data in the model data set for timing considerations, such as seasonal effects on a product's performance. The output of the analytical substeps of the forecast step 142 is a forecast data set. As in the other judgmental substeps, the user or the user's proxy may explore the forecast data set in order to ensure that the forecast data are as accurate and relevant as possible, such that the forecast generated for the new product will prove as useful as possible. The output of the forecast step 142 is a forecast function specification that then may be used to forecast the performance of the new product upon its introduction to the marketplace.

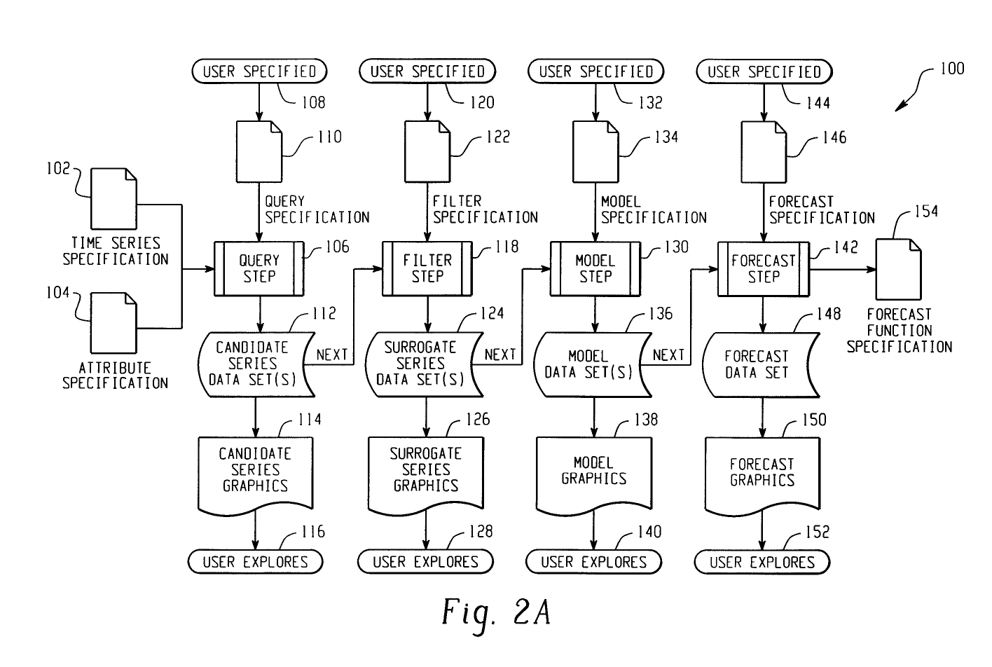

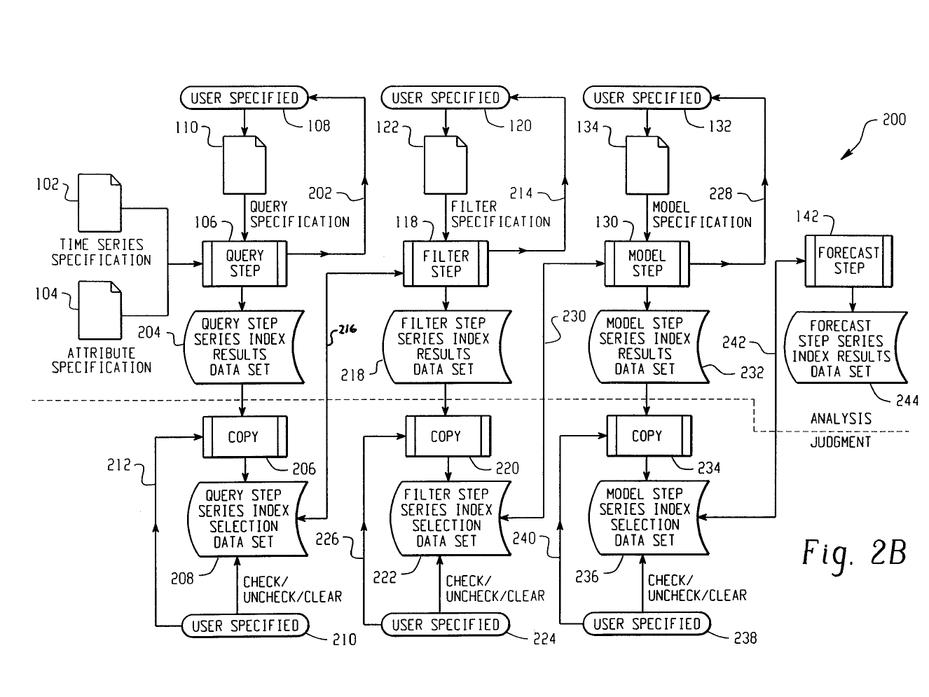

FIG. 2A provides additional details of a way to implement a query step 106, filter step 118, model step 130, and forecast step 142 in order to forecast the performance of a product to be introduced into the marketplace. With respect to FIG. 2A, processing for the system begins with time series specification 102 and attribute specification 104 being provided to the system 100. The time series specification 102 includes time series data regarding the historical performance of a product in the marketplace. For example, in the case of a motion picture, one such time series data might include the gross weekly receipts derived from sales of entry tickets to screenings of the motion picture at movie theaters in the United States. Another set of time series data could include the gross weekly receipts derived from sales of entry tickets to screenings of the motion picture at movie theaters in Europe, or more generally, gross weekly receipts in all countries outside the United States. In another example, the time series data could include the gross daily receipts derived from sales of entry tickets to screenings of the motion picture. These receipts, too, could be represented on any time basis, including daily, weekly, or monthly, and they could include amounts derived at any geographical granularity, from particular markets with a single country, to individual countries, regions, or the entire world.

The attribute specification 104 includes information about attributes of the product whose historical performance data was included in the time series specification 102. In the motion picture example, the attribute specification 104 could include data such as the title of the motion picture, the date on which the picture was released, the genre of the motion picture (e.g., drama, comedy, or horror), the content rating assigned to the motion picture in one or more countries or regions (e.g., the rating assigned by the Motion Picture Association of America, or MPAA®), the amount spent marketing the motion picture, the running time of the motion picture, and the primary language spoken in the soundtrack of the motion picture. All of this data is related to a particular product, which may be related to one or more time series specifications 102 containing data about the historical sales performance of the product.

Query step 106 takes as input the time series specification 102 and attribute specification 104 and filters the data contained in the specifications to identify the data most likely to be relevant to forecasting the performance of the new product. At 108, a user specifies the query specification 110, which also is input to the query step 106. The query specification 110 identifies attributes of the new product that the user considers important to identifying previously introduced products that are similar to the new product. In addition, the specification may includes values for the attributes identified by the user, where the values can be used to ensure that products that satisfy the elements of the query specification are sufficiently similar to the new product for their historical market performance data to be relevant to the generation of a forecast for the new product. The values specified for the attributes chosen by the user may be discrete or continuous.

Once the user has generated query specification 110, the query step 106 applies the query specification 110 to the overall set of historical market performance data. The overall set optimally contains historical market performance data for all products that have previously been introduced into the market in which the new product will be introduced, but a complete set is not necessary to the operation of the system. As an alternative, the historical market performance data may include data for products that have previously been introduced into markets that are similar to the market in which the new product will be introduced. For example, a company considering the introduction of a new food product may have historical market performance data only for the United States, but the company might consider the Canadian or British food markets to be similar enough to the U.S. market that the historical data from the U.S. market could be used to create a new product forecast for Canada or the U.K. The result of applying the query specification 110 to the overall set of historical market performance data is one or more candidate series data sets 112, each of which is a set of historical market performance data for products with attributes that satisfied the conditions of the query specification 110. Once they are included in the data set 112, time series of historical market performance data are referred to herein as candidate series.

The data in candidate series data set 112 is presented through a set of candidate series graphics 114. The use of candidate series graphics 114 simplifies the process of a user exploring the candidate series data, as shown at 116. The user explores the data in order to apply the user's judgment to the inclusion of each of the candidate series in later stages of the new product forecasting process. In addition, the candidate series graphics 114 may permit the user to override the generated results of the query step 106 and include as candidate series additional time series of historical market performance data for products that were not identified through query step 106 as matching the criteria in query specification 110, but which the user feels are similar products that could improve the accuracy of the forecasting process. As the user revises the candidate series data set 112, the candidate series graphics 114 are continually updated, thereby permitting the user to monitor graphically the data included in the data set 112. This further facilitates the user's inclusion of the most relevant candidate series data in the data set 112.

In an alternative approach to the query step, the identification of historical market performance data is provided by third-party software, such as Oracle or Teradata, which may be pre-existing parts of the product vendor's forecasting efforts. In yet another alternative approach, the query step is omitted entirely, and the candidate series data set 112 is provided directly by the user to commence the forecasting process.

Once the user is satisfied with the data included in the candidate series data set 112, the system 100 proceeds to the filter step 118. The candidate series data set 112 is input to the filter step 118. The filter step 118 removes from the input candidate series data set 112 those candidate series that are outliers with respect to the set of candidate series. If done properly, filtering the input data set 112 in this way should result in a data set containing series data related to products that are more similar to the new product than the group of products represented by the input data set 112. For this purpose, at 120 the user generates filter specification 122. A partial list of filters that the user may choose to use in the filter specification 122 includes reduction transformations, similarity measures, distance measures, clustering methods, and business rules. Also, these filters may be used individually or in combinations. For example, if a user wishes to forecast the performance of a new motion picture to be released into the marketplace, the user could specify that an exponential decay model be used to reduce each input data series. The user could further specify that, once the reduction is complete, the reduced data series should be clustered, and the largest cluster could be selected on the assumption that it is the most representative cluster.

Applying the filter specification 122 to the input data set 112 results in the creation of surrogate series data set 124. Each data series included in data set 124 now is referred to as a surrogate series. As was the case during the query step 106 with the candidate series data set 112, in filter step 118, once the surrogate series data set 124 is generated, the surrogate series graphics 126 may be employed by the user, as shown at 128, to explore the data series included in data set 124. The user explores the data in order to apply the user's judgment to the question of whether each of the surrogate series in the data set 124 should be included in later stages of the new product forecasting process. Further, the user may apply additional transformations to the data series in the data set 124, and the user also has the option to include additional data series in the surrogate series data 124 should the user believe that the additional data series will be useful to the further stages of the forecasting process.

It is noted that there is not a single accepted term in the field to represent data series such as those included in surrogate series data set 124. Those skilled in the art also may use similar terms, such as “analogy.”

If the user has chosen to apply a clustering method to the surrogate series, then the exploration and revising of the surrogate series data set 124 by the user may be done at the cluster level instead of the surrogate series level. Thus, in such an instance, the surrogate series graphics 126 would present cluster information to the user, rather than surrogate series information, and the user could select a cluster or clusters of surrogate series to remove from the data set 124 or the user could add an additional cluster or clusters of surrogate series to the data set 124.

Once the surrogate series data set 124 has been revised as needed by the user, the system proceeds to the model step 130, in which the surrogate series data set 124 serves as an input. Model step 130 extracts statistical features from the input data set 124. Because the input data set 124 includes market performance data series for those previously introduced products that are relatively highly similar to the new product, statistical features extracted from the input data set 124 may be useful in forecasting the performance of the new product.

In addition, at 132, the user specifies a model specification 134. A partial list of modeling techniques the user may incorporate in the specification 134 of the statistical model includes diffusion models, growth curves, neural networks, mixed models, and smoothing models. In addition, the statistical model can model the components of each series separately, and business rules also may applied at this step. In the example of the introduction of a new motion picture, the user could choose to include in the model specification 134 a model that decomposes the surrogate series into the total quantity series and the profile series. Then, the profile series can be modeled using a pooled smoothing technique and the total quantity can be modeled by the sample mean.

Once the user has specified the model specification 134, the model is fitted to the input data set 124 and the desired statistical features are extracted based on the model. The features thus extracted are included in one or more model data sets 136 and are used to compute pooled predictions for the set of surrogate series. Once the predictions are computed, prediction errors may be computed and evaluated for each surrogate series. In the example of introducing a new motion picture into the marketplace, the predicted profile series can be computed from the set of surrogate profile series, while the predicted total quantity can be computed from the mean of the surrogate total quantities. The predicted profile series and predicted total quantity then can be combined to form a prediction for the pool of surrogate cycle series.

After generating the model data set 136, the user may make use of the model graphics 138 to visually explore at 140 the model data set 136. The user may explore the surrogate series data from which the statistical features were extracted, as well as pooled model results and individual model results (i.e., model results for each surrogate series). In the motion picture example, the user might wish to explore the individual surrogate series model predictions and/or the prediction error evaluation statistics, examples of which can include root mean square error (RMSE), mean absolute percentage error (MAPE), and AIC. Based upon the user's exploration of the model data set 136, the user may apply his or her judgment to remove additional surrogate series from the remaining set of surrogate series data. For example, the user may determine from reviewing the model graphics 138 that there is a poor fit between the market performance data for one of the previously released motion pictures and the model predictions, and the user then may decide to remove the market performance series data associated with that motion picture from the surrogate series data set.

Once the model data set 136 has been revised as needed by the user, the system proceeds to the forecast step 142, in which the model data set 136 serves as an input. Forecast step 142 uses the pooled predictions associated with the features extracted from the set of surrogate series. Also, in this step, the model forecasts are adjusted to take into account the fact that forecasts for the performance of products newly introduced into the marketplace are connected to a particular time period and season, whereas the historical market performance data (provided it is sufficiently large) represents times throughout the year. Correcting for this is performed because the failure to do so may lead to skewed results. For example, a motion picture that is a family comedy may perform better if it is released at a time when most children are not attending school or during the holiday season. If, however, the new motion picture for which the forecast is to be created is a comedy intended for an audience that does not include children and it is planned for release at a time when children are in school, the market performance series data for the family motion picture may be skewed towards a different time period, which could affect the overall reliability of the forecast for the new product.

In addition to the model data set, at 144 the user specifies a forecast specification 146 as an additional input into the forecast step 142. The forecast specification 146 describes the timing of the release of the new product. After the forecast specification 146 is specified by the user, the model forecasts for the new product are compensated for timing considerations. The result is the forecast data set 148, which the forecast graphics 150 facilitate visual exploration by the user 152. The user may apply his or her judgment to determine that one or more of the model predictions should be overridden. For example, with the release of a new motion picture, the user may adjust the total revenue predicted to be derived from ticket sales, or he or she may hold constant the total revenue to be derived from ticket sales while adjusting the percentage of the total predicted to be derived during particular time periods. Once the user has applied his or her judgment to the forecast data set 148 and is satisfied with the forecasts it contains, the forecast step 142 ends, outputting a forecast function specification 154. The forecast function specification 154 is used to generate a forecast for the performance of the new product in the marketplace.

FIG. 2B depicts the operations of a new product forecasting system 200 that have been delineated according to whether the steps are analytic steps or judgmental steps, where judgmental steps represent the optional intervention of a human user to apply the user's judgment to one or more aspects of system 200.

Query step 106 takes as input time series specification 102 and attribute specification 104. In addition, a user specifies at 108 a query specification 110, which identifies attributes and values for attributes that define what products the user considers similar to the new product for purposes of creating a forecast model. Query specification 110 is an additional input to query step 106. Query step 106 applies query specification 110 to an overall set of historical market performance data. As shown at 202, the user may modify the query specification 110 if, in the user's judgment, revised attributes and/or values would result in a more accurate selection of similar products from the overall set of historical market performance data. Once the user is satisfied that query specification 110 will select the most accurate subset of the overall set of historical market performance data, the query specification 110 is applied to the overall set of historical market performance data to produce query step series index results data set 204, which is saved in order to permit the user to revisit query step 106 at a later point in method 200 and make further adjustments to query specification 110 or data set 204.

Once the data set 204 has been saved, it is copied at 206 to query step series index selection data set 208. Data set 208 also is saved, after which the user may apply judgment modifications to data set 208, as shown at 210, including selecting or deselecting one or more of the product data series present in data set 208. The saving of data set 208 permits the resetting of any judgment modifications applied to data set 208, as shown at 212. If the user decides to make use of the reset option to undo the judgment modifications to the data set 208, data set 208 is returned to the saved version of data set 204. The saved version of data set 204 is copied again at 206, thereby resetting data set 208. When the user has completed any judgment modifications to and/or resetting of data set 208, data set 208 becomes an input to filter step 118.

Filter step 118 takes as input the data set 208 generated as a result of the query step 106 and optionally modified by the user. Also, at 120, the user specifies a filter specification 122, which indicates which of the available filters should be applied to the data set generated in the query step 106. The filters may be used individually or in combinations. The primary goal of filter step 118 is to remove from input data set 208 those products that are statistically least similar to the new product. Once filter specification 122 has been applied to input data set 208, the user may review the results and decide to modify the filter specification, as depicted at 214.

Also, as shown at 216, at any point where the user is performing the filter step 118 of method 200, the user may decide to return, or go back, from the filter step 118 to the modification of data set 208 within the context of the judgment aspects of query step 106. This may be done, for example, if the user realizes upon seeing the results of the application of filter specification 122 to input data set 208 that one or more product data series that were removed from data set 208 should have been included, or that one or more product data series that were included in data set 208 should have been removed. If the user exercises this option, then once the necessary modifications to data set 208 are complete, the system returns to filter step 118, where the user may re-specify a filter specification 122.

Once the user is satisfied that filter specification 122 includes the most appropriate statistical filter(s), filter specification 122 is applied to input data set 208, which results in the creation of filter step series index results data set 218. Data set 218 is saved in order to permit revisiting of the analytic aspects of filter step 118 later in system 200. Once data set 218 has been saved, it is copied at 220 to filter step series index selection data set 222. At this point, as shown at 224, the user may apply judgment modifications to data set 222, including selecting product data series to remove or include in data set 222. If during the judgment aspects of filter step 118, the user decides that it would be preferable to undo any judgment modifications to data set 222, the reset option 226 is available to the user. Use of reset option 226 causes data set 222 to be reverted to the version of data set 218 that was saved previously, and the saved version of data set 218 is copied again at 220, thus resetting data set 222. When the user has completed any judgment modifications to and/or resetting of data set 222, data set 222 becomes an input to model step 130.

Model step 130 takes as input the data set 222 generated as a result of filter step 118. Also, the user specifies at 132 a model specification 134, which specifies which modeling techniques the user believes should be used within method 200 to extract statistical features from input data set 222. Model step 130 applies model specification 132 to input data set 222. As shown at 228, the user may modify the model specification 134 if, in the user's judgment, the results of applying the initial model specification are somehow unsatisfactory. Also, as shown at 230, at any point where the user is performing model step 130, the user may decide to return, or go back, from model step 130 to the modification of data set 222 within the context of the judgment aspects of filter step 118. Once the user is content with model specification 134, it is applied to input data set 222 to create model step series index results data set 232. Data set 232 is saved in order to permit revisiting of the analytic aspects of model step 130 later in method 200.

After data set 232 is saved, it is copied at 234 to model step series index selection data set 236. As shown at 238, the user may apply judgment to data set 236 in order to ensure that the modeling characteristics contained in data set 236 will produce an accurate forecast with respect to performance of the new product. The user has the option to reset 240 the judgment modifications made to data set 236, which causes data set 236 to revert to the version of data set 232 that was saved and copied initially at 234 to data set 236. Once the user is satisfied with data set 236, it becomes the input to forecast step 142.

Forecast step 142 applies the modeling features extracted from the historical market performance data during the previous steps to the new product, while correcting for timing considerations. While performing forecast step 142, the user may go back to the modification of data set 236 in the judgment aspects of model step 130, as shown at 242. Once the user is satisfied that the extracted modeling features will produce an appropriate forecast, the forecast is applied to the new product to produce forecast step series index results data set 244.

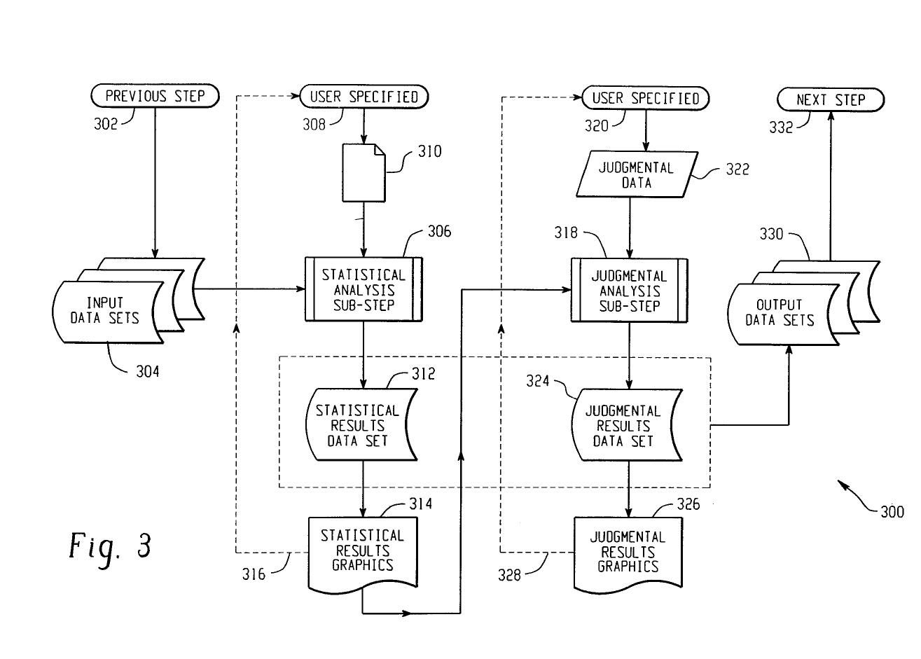

FIG. 3 illustrates a generic set of substeps (e.g., a template) for applying structured judgment analysis to any of the query, filter, model, or forecast steps. As shown in FIG. 3, operation begins with a previous step 302 (e.g., a query step), the output of which becomes the input data sets 304 to another step 300 (e.g., a filter step). The first aspect of step 300 is a statistical analysis sub-step 306. Statistical analysis sub-step 306 takes as input the input data sets 304. Also, at 308, the user specifies analysis specification 310, which becomes an additional input to statistical analysis sub-step 306. The application of analysis specification 310 to input data sets 304 produces statistical results data set 312. The data in statistical results data set 312 is displayed to a user through the statistical results graphics 314, which a user may use to assess whether the analysis specification 310 included the most accurate and useful data in data set 312. If the user feels that the analysis specification did not produce the most accurate and useful data, then the user may modify the analysis specification 310, as shown at 316. The result is a modified analysis specification 310, which is input to statistical analysis sub-step 306, where the modified analysis specification is applied to input data sets 304. The result is a modified statistical results data set 312, the contents of which are viewed by the user through the use of the statistical results graphics 314. The cycle of reviewing the data in data set 312, modifying the analysis specification 310, and repeating the application of analysis specification 310 to input data sets 304 may be repeated as often as the user wishes.

Once the user is satisfied that the data in data set 312 is the most accurate and useful data, the data set becomes an input to judgmental analysis sub-step 318. As shown at 320, the user specifies judgmental data 322 as an additional input to judgmental analysis sub-step 318. This judgmental data 322 may take many forms, examples of which include an informal process of selecting what data to include in or exclude from the data set input to sub-step 318 or a formally defined set of rules that can be applied to duplicate the judgment of a user. The application of judgmental data 322 to the data set input to sub-step 318 produces judgmental results data set 324.

The user may examine the data in judgmental results data set 324 using judgmental results graphics 326, in order to determine if data set 324 contains the most appropriate data to be output from method step 300. As shown at 328, if the user feels that data set 324 should be revised, the user may specify modified judgmental data 322. This modified judgmental data is applied to the data set input from the statistical analysis sub-step to produce a modified judgmental results data set 324. As in the statistical analysis sub-step, the cycle of reviewing the data in data set 324, modifying the judgmental data 322, and re-applying the judgmental data to the input data set may be repeated as often as the user wishes. Once the user is satisfied that the judgmental results data set 324 is correct, the data is copied to output data sets 330, where they comprise the input to the next step 332 in the forecasting process.

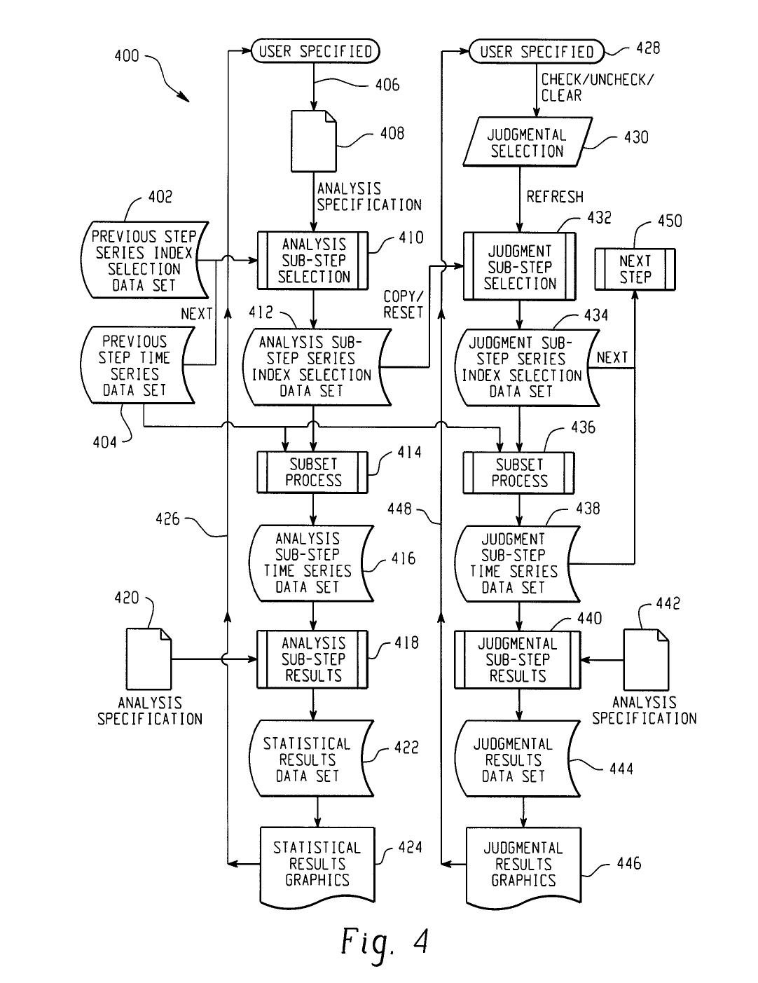

It should be understood that the operations of FIG. 3 can be implemented in many different ways, such as in the approach shown in FIG. 4. FIG. 4 depicts at 400 the sub-steps associated with an arbitrary major step in the new product forecasting process that focuses on combining statistics and judgment in selecting similar products for use in generating a forecast for the performance of the new product. In this example, the user focuses on series index selection. A series index identifies a data series for a particular product within the overall set of historical market performance data for all products that are similar to the new product. For example, if N represents the number of products similar to the new product for which historical market performance data is available, i represents the series index, and DS indicates a data series for a particular similar product, then the set of data series for all similar products is represented as DS₁ . . . DS_{N}, while an arbitrary data series within the set would be referred to as DSᵢ. Thus, if the fifteenth similar product should be included in a particular data set, the series index selection related to that data set would include at least DS₁₅, which could be represented simply by selecting i=15. An exemplary series index selection data set is the previous step series index selection data set 402, which in this example contains all of the series for similar products selected pursuant to the step prior to the step illustrated in the figure.

Associated with each similar product is a time series data set. The time series data set contains the time series for a particular similar product, which comprises the dependent time series vector and the independent time series vector for the similar product. Let y_{i,t} represent a single dependent time series value for series i, such as, for example, gross receipts derived from sales of entry tickets to screenings of a motion picture, where

tγ{tᵢ^{b}, . . . , tᵢ^{e}}

in which tᵢ^{b} and tᵢ^{e} represent the beginning and ending time index for the i^{th} series, respectively, or the time period when the similar product was on the market, such as the weeks when a motion picture was “in theaters.” Then, \vec{y}ᵢ is the dependent time series vector, representing the sum of y_{i,t} for all values of t. The independent time series vector, on the other hand, helps model or predict values for y_{i,t} as the independent time series vector may include, for example, information about pricing, marketing budget, inventory, or other causal factors that could have affected the magnitude of y_{i,t} for period t. An exemplary time series data set is previous step time series data set 404.

As shown at 406 in FIG. 4, the user specifies analysis specification 408, which describes the analytical process for selecting a series and how a selected series should be analyzed and graphically displayed. At 410, the analysis sub-step selection uses previous step series index selection data set 402 and previous step time series data set 404, along with analysis specification 408 to create the analysis sub-step series index selection data set 412. Using data set 412, subset process 414 generates a subset of previous step time series data set 404 to form the analysis sub-step time series data set 416. At 418, the analysis sub-step time series data set 416 is combined with analysis specification 420 to produce statistical results data set 422. The user may use statistical results graphics 424 to explore statistical results data set 422 and at 426, make modifications to the analysis specification 408 used in the analysis sub-step.

Once the user is satisfied with the results of the analysis sub-step, the analysis sub-step series index selection data set 412 becomes an input to the judgment sub-step. At 428, the user specifies judgmental selection 430, which may comprise a series selected according to the analysis specification in the analysis sub-step. The user's judgmental selection 430 is combined at 432 with the input data copied from data set 412 to create the judgment sub-step series index selection data set 434. At 436, a subset of data set 434 is generated, using the previous step time series data set 404, which results in the creation of judgment sub-step time series data set 438. At 440, the analysis specification 442 is applied to data set 438, producing judgmental results data set 444, which the user may explore with judgmental results graphics 446. If the user wishes to modify 448 the judgmental selection 430 that was applied in the judgment sub-step, then the judgment sub-step is repeated using the modified judgmental selection. Once the user is satisfied with the results of the statistical analysis, the user can choose to move on to the next step in the process, whereupon judgment sub-step series index selection data set 434 and judgment sub-step time series data set 438 become inputs to the next step 450.

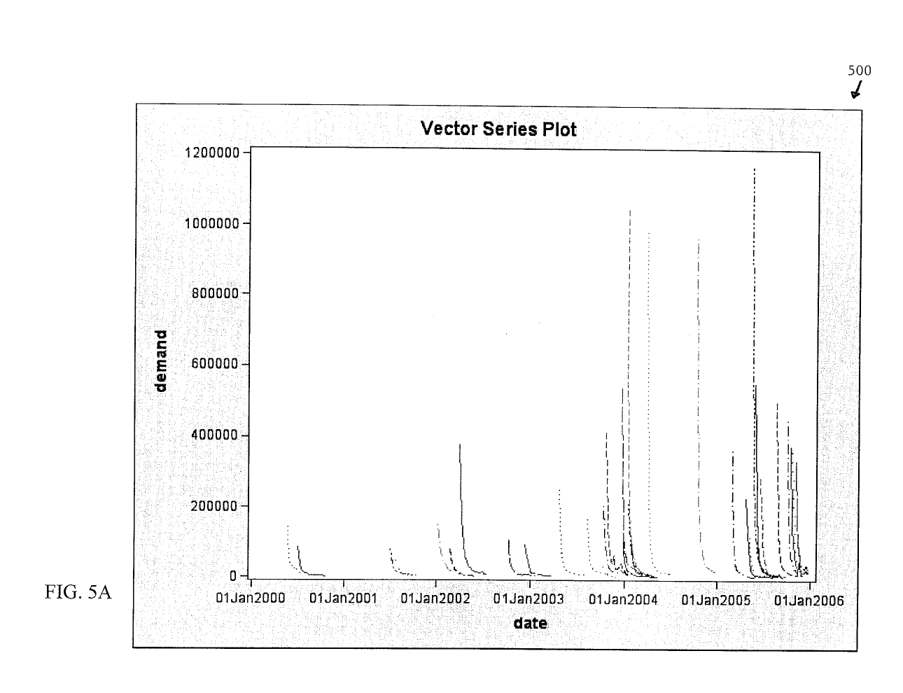

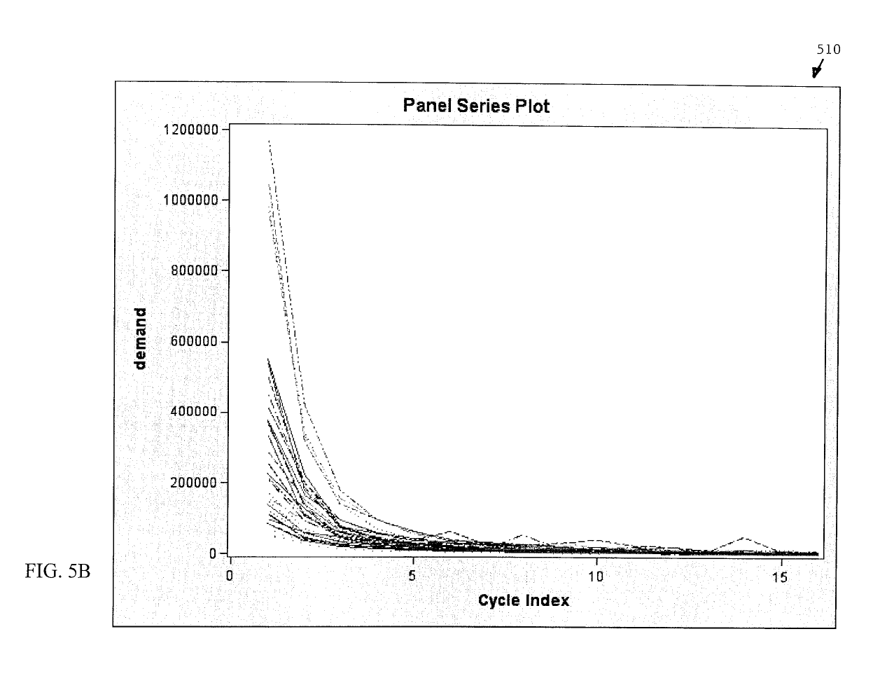

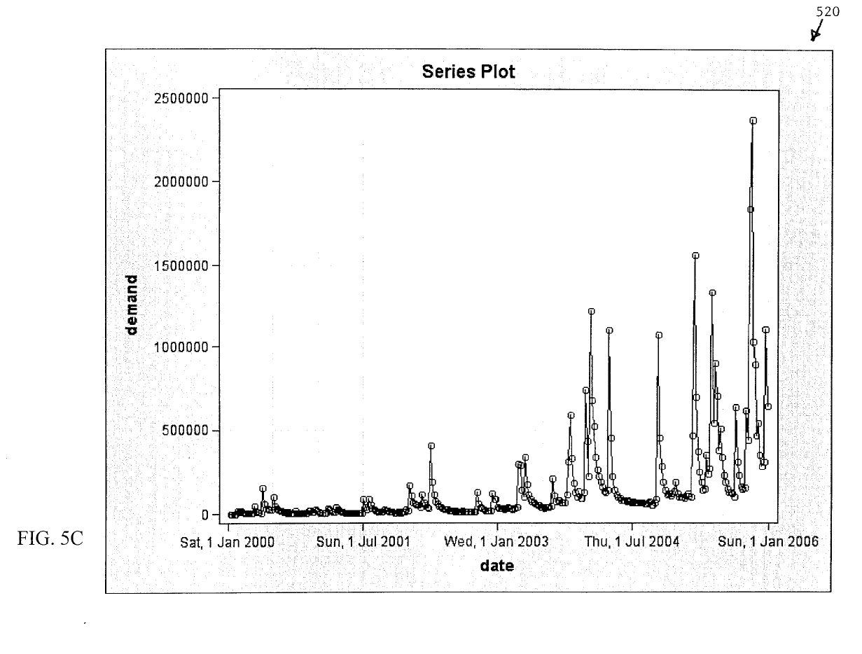

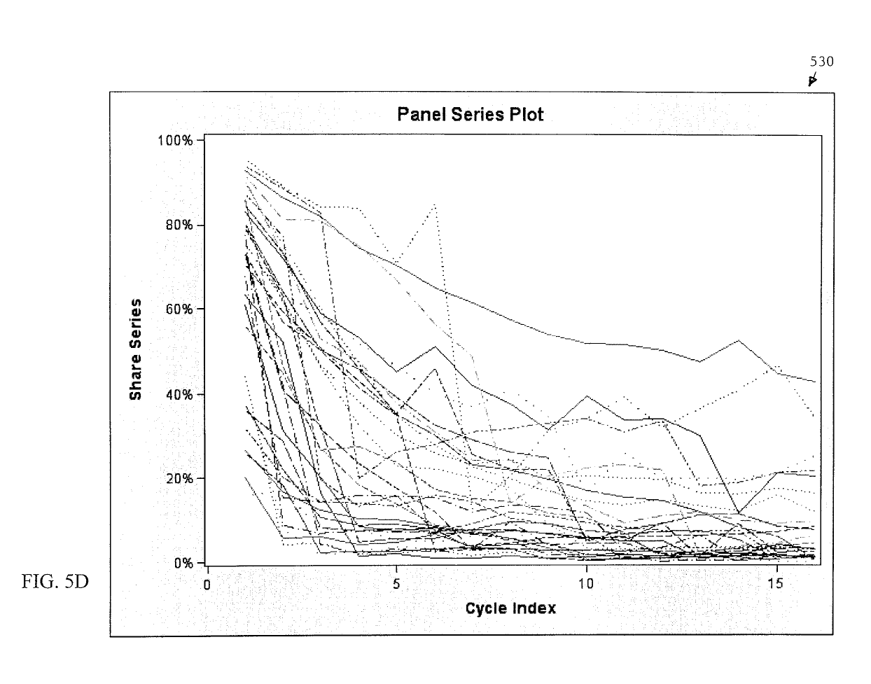

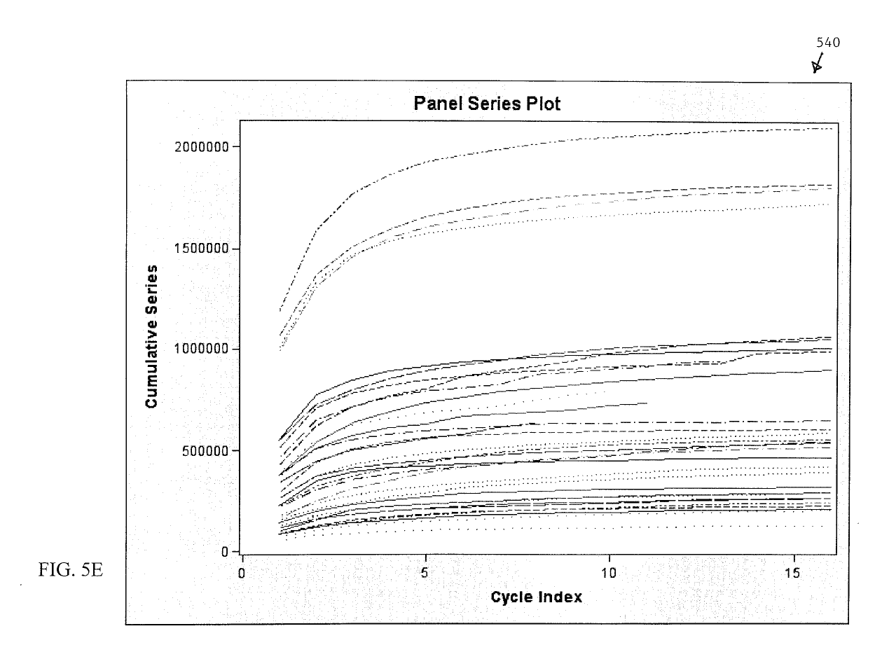

The new product forecasting system can handle many different types of data, such as collected and/or derived data. FIGS. 5A-5E are graphs illustrating various examples of collected and derived historical market performance series data for a previously introduced product as well as ways in which a user can visualize such data. For example, FIG. 5A depicts at 500 time series data for the quantity sold of a group of products, over a seven-year timeframe. Specifically, the graph depicts the dependent time series values for the products.

FIG. 5B depicts a graphical representation 510 of cycle series data for the quantity sold of a group of products, over a cycle timeframe of approximately 15 cycles. Cycle series data is derived from time series data, but rather than representing the time series data on an absolute time scale (e.g., the sales of each product during the first week of January, 2007 or for the day of Jul. 3, 2005), cycle series data sets the introduction of each product as “cycle 1” in the derived data series, and the time series data for each product is adjusted to this relative scale. Thus, if product 1 were introduced on Aug. 1, 2006 and product 2 were introduced on Sep. 15, 2007, and the cycle timeline is daily, sales of product 1 on Aug. 1, 2006 and sales of product 2 on Sep. 15, 2007 each would be represented in the first position on the horizontal axis (i.e., cycle 1), with each product's daily sales being graphed sequentially from that point on the graph. In the example of motion picture ticket sales revenue, similar pictures may be introduced months or years apart, and it is very likely that, given that passage of time, the earlier picture will no longer be in the theaters when the later picture is released. Thus, viewing the ticket revenue for the two pictures on an absolute time scale would not convey meaningful information. However, adjusting to a relative time scale, such as ticket sales for the first week of release, will present the data in a way that is more useful, allowing a user, for example, to see what correlations, if any, exist between the revenue derived by the earlier picture and the revenue derived by the later picture in their various weeks of release.

FIG. 5C depicts at 520 a graph of an aggregate time series. The aggregate time series may represent, for example, the sum of time series data for all selected series i at a particular time t, or it may be based on the average of the time series data at time t or another aggregation. Also, the aggregate time series data may be derived on the basis of the time series data for each of the selected series i, or it may be supplied as a data set separate from the time series data. In addition, the aggregate time series data may have associated with it an independent time series vector, which may help model or predict values for the aggregate time series data, such as by providing macro-econometric inputs.

FIG. 5D includes a graph 530 showing share series data for a group of products. Share series data is derived from the aggregate time series data and the cycle series data for the group of products, and it describes the relative demand for each product over the cycle index. A share series may be formed from the cycle series y_{i,l} and the aggregate time series yₜ^{A} as follows:

v_{i,l}=y_{i,l}/yₗ^{A} for l=1 . . . Lᵢ where l=(t+1−tᵢ^{b})

and

\vec{v}ᵢ={v_{i,l}}ₗ₌₁^{L}^{ᵢ}

represents the share series vector for the i^{th} series. In other words, v_{i,l} would represent the percentage of the market for the i^{th} historical product at the l^{th} cycle index with respect to the aggregate time series. It should be noted that all share series have a common cycle index and common scale.

FIG. 5E depicts at 540 a graph containing cumulative series data. Cumulative series data describes the cumulative demand for a product over the cycle index, information which may be useful, for example, for diffusion models when a saturation level must be estimated. Cumulative series data c_{i,l} is derived from the cycle series data y_{i,l}, according to the following formula:

$${c}_{i , l} = {\sum }_{j = i}^{l} {y}_{i , l} for l = 1 , … , {L}_{i}$$

$$and$$

$${\vec{c}}_{i} = {\{ {c}_{i , l} \}}_{l = 1}^{{L}_{i}}$$

represents the cumulative series vector for the i^{th} series. Thus, if l=10, then c_{i,l} represents the total quantity of product sold within the first ten cycles after the product was introduced.

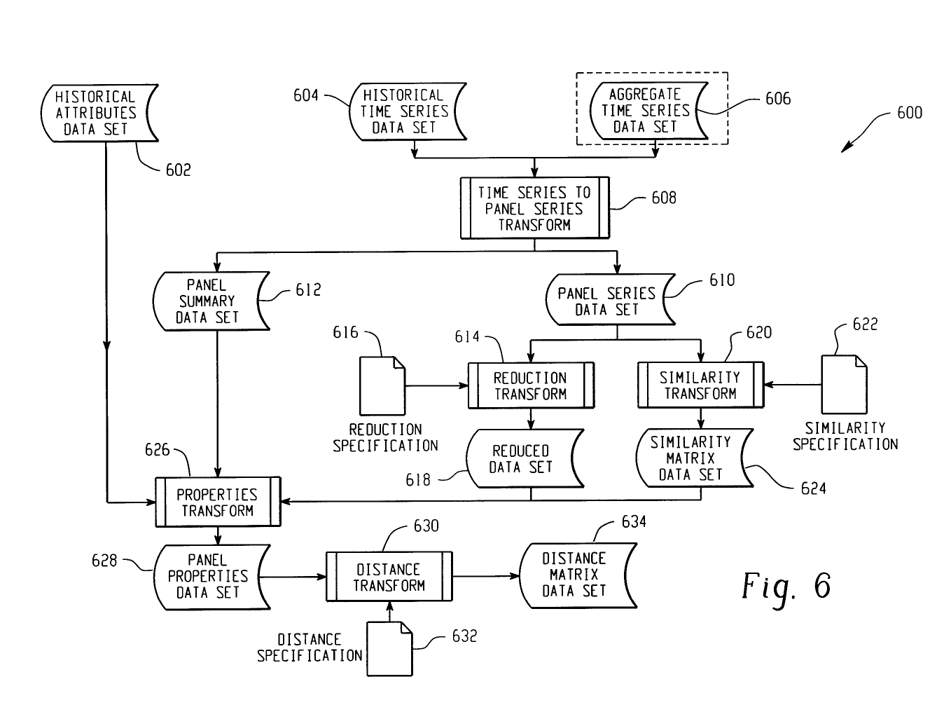

Data that can be processed by the new product forecasting system includes derived data (e.g., as shown in FIG. 5B). FIG. 6 provides an example of how derived data can be generated within the new product forecasting system. More specifically, FIG. 6 depicts at 600 processes involved in the derivation of the derived historical product data sets from the historical data sets that are supplied. The inputs to the derivation processes are historical attributes data set 602, historical time series data set 604, and optionally, aggregate time series data set 606. If aggregate time series data set 606 is not supplied, then it is derived prior to commencing the other derivation processes. Historical time series data set 604 and aggregate time series data set 606 (whether supplied or derived) are input to time series to panel series transform 608. Time series to panel series transform 608 operates on the input data to generate the panel series data set 610, which includes the range of derived data sets, including for example, cycle series data, share series data, and cumulative series data, and the panel summary data set 612, which may be represented as Qᵢ. At 614, using a time series reduction specification 616, such as \vec{r}ᵢ=R(Zᵢ), the panel series data set 610 is transformed into reduced data set 618, which may be represented as \vec{r}ᵢ. Using a time series similarity specification 622, such as s_{i,j}=Sim(Zᵢ,Zⱼ), the panel series data set 610 is transformed into similarity matrix data set 624, which may be represented as s_{i,j}. At 626, panel summary data set 612, reduced data set 618, similarity matrix data set 624, and historical attributes data set 602 are merged to form the panel properties data set 628. Finally, at 630, the panel properties data set 628 is transformed using a distance measure, as specified at 632, for example d_{i,j}=D(\vec{z}ᵢ^{P},\vec{z}ⱼ^{P}). The result is distance matrix data set 634, which may also be represented as d_{i,j}.

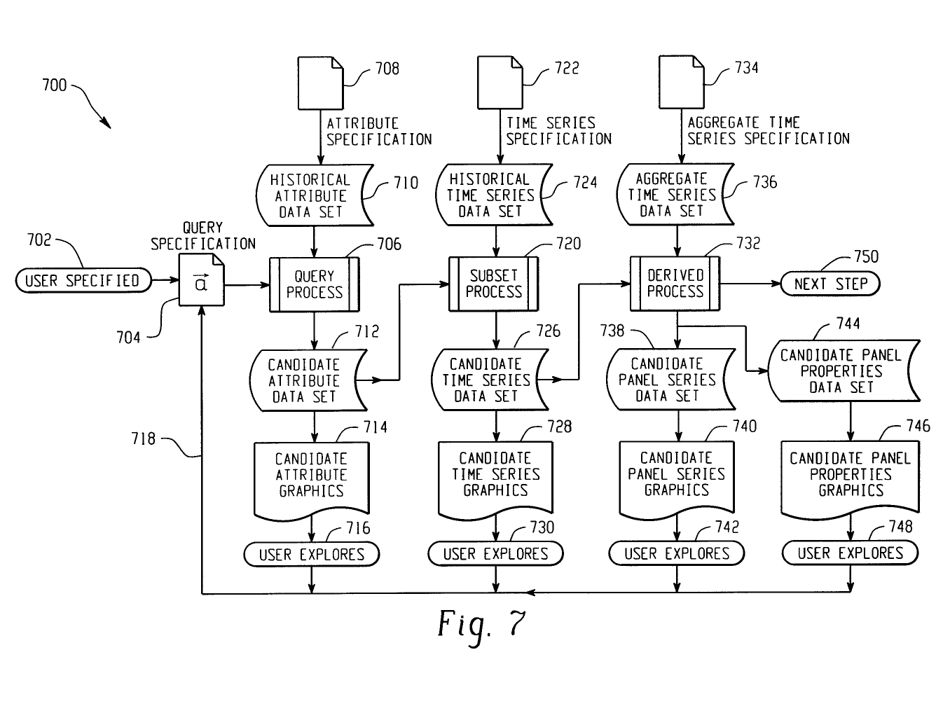

As discussed above, the new product forecasting system includes a query step. FIG. 7 depicts at 700 additional details of the query step. Aspects of the more detailed depiction of the query step incorporate, for example, the derivation processes discussed above with reference to FIG. 6, as well as the querying and subset procedures discussed above with reference to FIG. 2A and FIG. 4, respectively. Thus, for example, at 702 a user specifies a query specification, which is input to the query process 706. In addition, the user specifies an attribute specification, which is applied to the historical attribute data set 710, with the result comprising an additional input to query step 706. The query step combines the inputs to produce the candidate attribute data set 712, which candidate attribute graphics 714 permit the user to explore, as shown at 716, and the user may modify at 718 the query specification based on the exploration at 716. Once the data set 712 is satisfactory, it becomes an input to subset process 720. In addition, at 722 the user specifies a time series specification, which is applied to historical time series data set 724, the result comprising an additional input to subset process 720. Subset process 720 combines the inputs to generate candidate time series data set 726. Candidate time series graphics 728 facilitate exploration by the user of data set 726, as shown at 730. The user may modify at 718 the query specification based on the exploration 730. Once the data set 726 is satisfactory, it becomes an input to the derivation process 732. Also, the user specifies an aggregate time series specification 734, which is applied to aggregate time series data set 736, the result of which comprises an additional input to the derivation process 732. Derivation process 732 produces candidate panel series data 738, which candidate panel series graphics 740 permit the user to explore 742, and candidate panel properties data set 744, which candidate panel properties graphics 746 permit the user to explore 748. Based on either of the exploration steps 742 or 748, the user may modify 718 the query specification. Once the candidate panel series data set 738 and candidate panel properties data set 744 are satisfactory, they become the input to the next step 750.

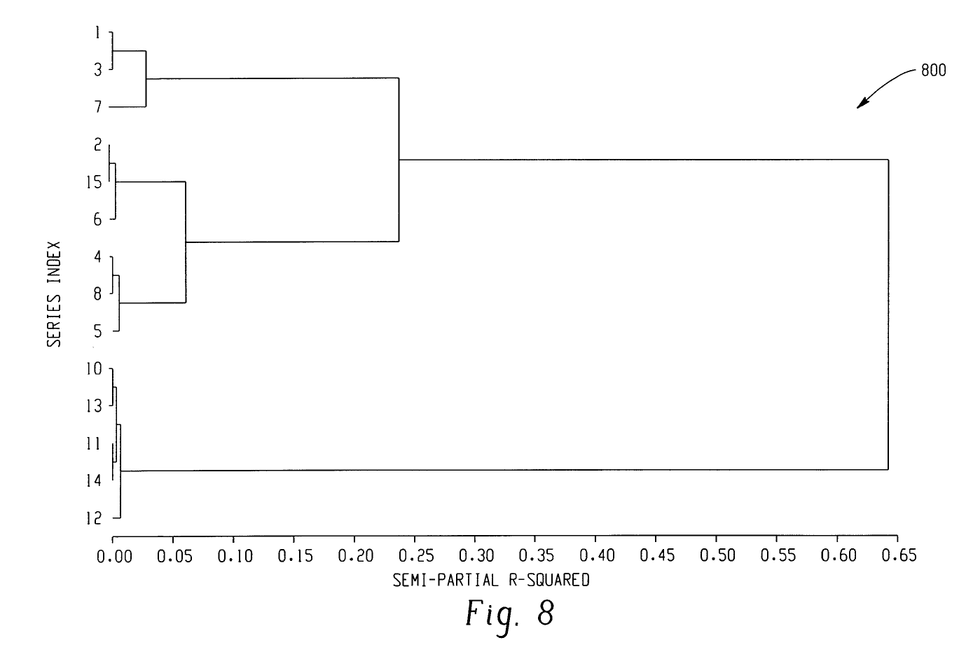

As discussed above, the new product forecasting system includes a filter step. For example, a user may choose to use distance measures as the filter. As an illustration, FIG. 8 provides an example dendrogram that depicts information contained in a distance matrix of a cluster of historical market performance series data. The following is an example of a distance matrix:

D={\vec{d}ᵢ}ᵢ₌₁^{N}

Given the distance matrix, a clustering method may be specified by the user to be applied to the data, which could for example result in clusters as depicted in dendrogram 800. In the dendrogram 800, the largest of the more significant clusters consists of series indices 1, 3, 7, 2, 15, 6, 4, 8, and 5. The smaller of the more significant clusters consists of series indices 10, 13, 11, 14, and 12. If, on the other hand, four clusters are considered, then the cluster consisting of series indices 10, 13, 11, 14, and 12 would be the largest and most significant. This clustering may be used as part of the filter step in forecasting the performance of a new product, in order to remove from the candidate data set any outliers that might tend to reduce the accuracy of the models extracted from the data set of products similar to the new product.

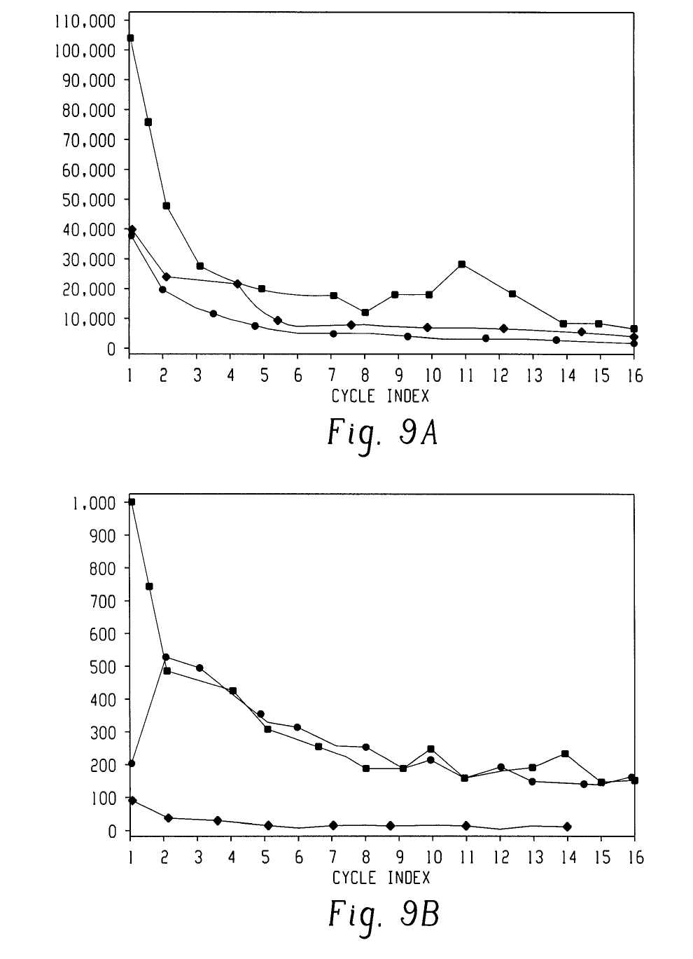

FIGS. 9A and 9B are examples of plots of the cycle series of two of the clusters represented in the dendrogram of FIG. 8. These provide the user with additional information about the relationships between the products chosen in the query step and whether the set of similar products chosen in the query step should be altered before the results are passed to the next step.

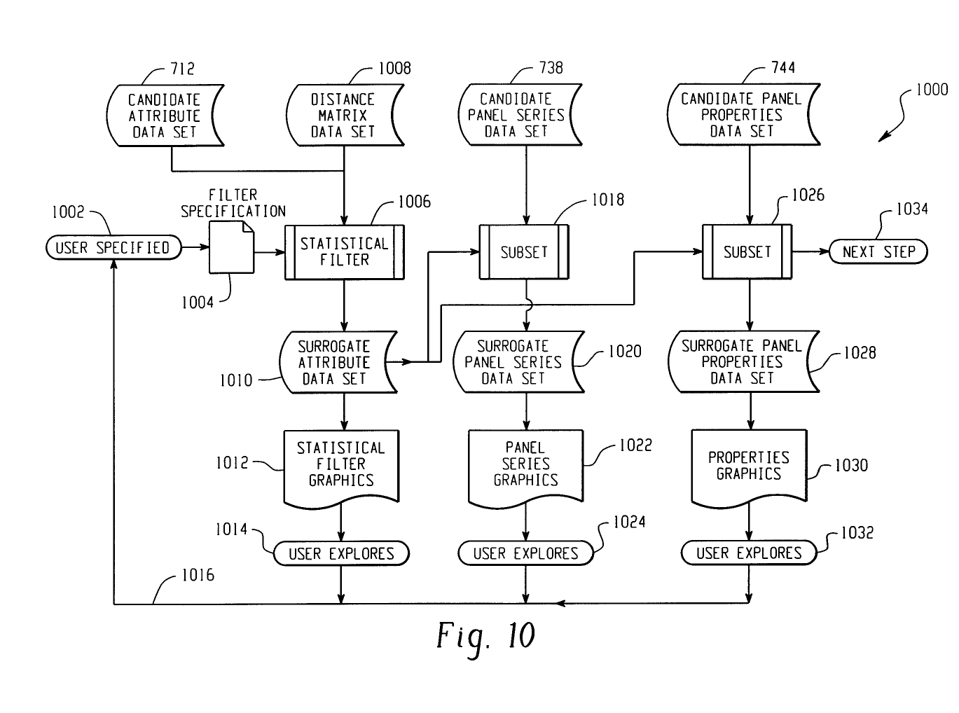

FIG. 10 depicts at 1000 additional details of the filter step. Aspects of the more detailed depiction of the filter step may incorporate, for example, the visualizations of FIGS. 8, 9A, and 9B, as well as the filtering and subset procedures discussed above with reference to FIG. 2A and FIG. 4, respectively. In this example, a user specifies at 1002 the filter specification 1004 that is input into statistical filter 1006. Statistical filter 1006 also takes as inputs candidate attribute data set 712 and distance matrix data set 1008, where data set 712 was an output of the query step described in FIG. 7. Statistical filter 1006 combines the inputs to generate surrogate attribute data set 1010. The statistical filter graphics 1012 allow the user to explore 1014 the data set 1010. If the user feels, based on the exploration 1014, that changes are needed to make the data set 1010 more useful and accurate, then changes are incorporated into the filter specification, as shown at 1016.

Once the data set 1010 is properly defined, it becomes an input to the subset operation at 1018. Subset operation 1018 also takes as input candidate panel series data set 738, which was one output of the query step described in FIG. 7. The subset operation 1018 combines the inputs to generate surrogate panel series data set 1020. The surrogate panel series data set 1020 may include one or more of the data series listed below, which may be derived given a set of statistically filtered candidate series indices, i=1 . . . N.

### Surrogate Panel Series:

(\vec{z}_{i,l}=y_{i,l},v_{i,l},c_{i,l},c_{i,l}^{%},q_{i,l},Qᵢ,\vec{x}_{i,l})

Surrogate Time Series: y_{i,t}

Surrogate Cycle Series: y_{i,l}

Surrogate Share Series: v_{i,l}

Surrogate Cumulative Series: c_{i,l}

Surrogate Cumulative % Series: c_{i,l}^{%}

Surrogate Profile Series: q_{i,l}

Surrogate sum of the cycle series: Qᵢ

Surrogate Input Series Vector: \vec{x}_{i,l}

The panel series graphics 1022 facilitate the user's exploration 1024 of the data set 1020. If the user feels that the data set 1020 requires modification, then changes are incorporated into the filter specification, as shown at 1016.

Subset operation 1026 also accepts as input surrogate attribute data set 1010. Subset operation combines data set 1010 with candidate panel properties data set 744, a data set that was one output of the query step illustrated in FIG. 7. This combination produces surrogate panel properties data set 1028. The surrogate panel properties data set 1028 may include one or more of the data series listed below, which may be derived given a set of statistically filtered candidate series indices, i=1 . . . N.

### Surrogate Panel Properties:

\vec{z}ᵢ^{P}=(Qᵢ,\vec{a}ᵢ,\vec{r}ᵢ,\vec{s}ᵢ)

Surrogate sum of the cycle series: Qᵢ

Surrogate's Attribute Data Vector: \vec{a}ᵢ

Surrogate Reduced Data Vector: \vec{r}ᵢ

Surrogate Similarity Vector: \vec{s}ᵢ

Properties graphics 1030 permit the user to explore 1032 the data set 1028, and any changes the user feels are needed to improve data set 1028 are incorporated into filter specification 1004, as shown at 1016. Once the subset operations are complete, the process may move to the next step 1034.

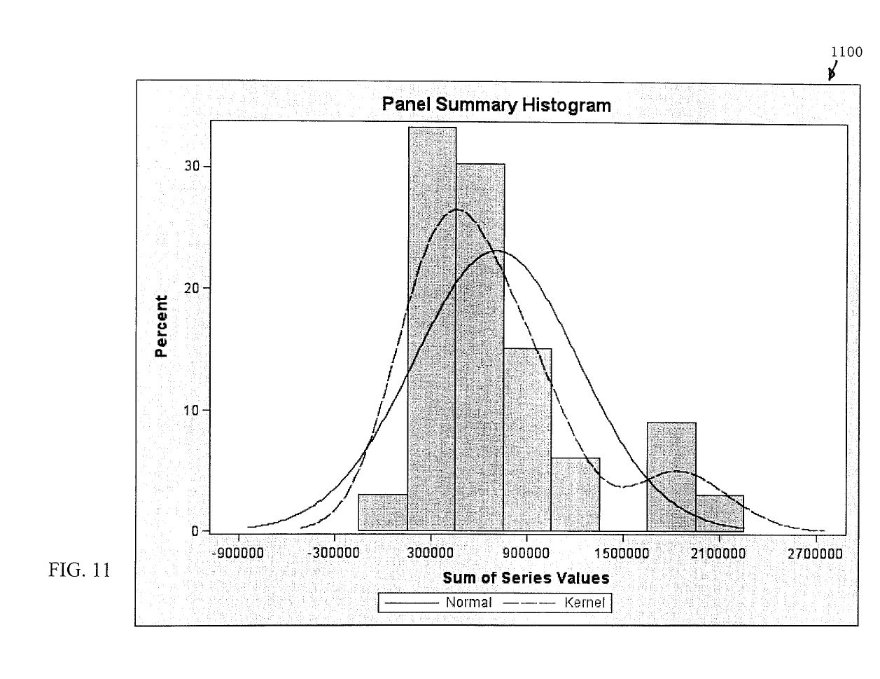

As discussed above, the new product forecasting system includes a model step. The model step can be configured in many different ways in order to extract modeling features from the output of the filter step (i.e., the surrogate data series). For example, FIG. 11 depicts at 1100 the predictions generated by a particular type of model (i.e., panel summary model) processing surrogate data series from the filter step. The values presented are for the surrogate series values, Qᵢ. The vertical reference lines represent the prediction, \hat{Q}, and its 95% confidence limits. Given the surrogate panel series data created, for example, as described in FIG. 10, a forecast for the new product can be generated using a forecasting method, F( ), specified by the user:

(yₗvₗ,cₗ,cₗ^{%},qₗ,Q)=(F{Zᵢ}ᵢ₌₁^{N},{\vec{z}ᵢ^{p}}ᵢ₌₁^{N}:θ)

where F( ) represents the forecasting method, Zᵢ represents the surrogate panel series matrix for the i^{th} dependent series, \vec{z}ᵢ^{p} surrogate panel properties vector for the i^{th} dependent series, θ represents the parameter vector to be estimated, and (yₗ, vₗ, cₗ, cₗ^{%}, qₗ, Q) represents the new product panel series to be predicted. The new product series are not subscripted by the series index, i, because they are not contained in the historical data. Typically, the forecasting method only predicts the cycle series, yₗ, the share series and the aggregate series (rᵢ, yₗ^{A}), the cumulative series cₗ, the cumulative percent series and the sum of the cycle series (cₗ^{%}, Q), or the profile series and the sum of the cycle series, (qₗ, Q). From any of these predictions, the others can be readily computed, due to the relationship:

yₗ=vₗyₗ^{A}=cₗ−cₗ₋₁=(cₗ^{%}−cₗ₋₁^{%})Q=qₗQ and when l=1, yₗ=cₗ=cₗ^{%}Q=qₗQ

Typically, when the forecasting method predicts both the share series and the aggregate time series, it is done in the following separate models:

vₗ=F₁({Zᵢ}ᵢ₌₁^{N}:θ₁)

yₜ^{A}=F₂((yₜ^{A},\vec{x}ₜ^{A}):θ₂)

where F₁( ) represents the share series and F₂( ) represents aggregate time series forecasting methods, respectively.

Typically, when the forecasting method predicts both the cumulative percentage series and the sum of the cycle series, it is done in the following separate models:

cₗ^{%}=F₁({Zᵢ}ᵢ₌₁^{N}:θ₁)

Q=F₂({\vec{z}ᵢ^{P}}ᵢ₌₁^{N}:θ₂)

where F₁( ) represents the cumulative percentage series and F₂( ) represents sum of the cycle series forecasting methods, respectively.

Typically, when the forecasting method predicts both the profile series and the sum of the cycle series, it is done in separate models.

qₗ=F₁({Zᵢ}ᵢ₌₁^{N}:θ₁)

Q=F₂({\vec{z}ᵢ^{P}}ᵢ₌₁^{N}:θ₂)

where F₁( ) represents the profile series and F₂( ) represents sum of the cycle series forecasting methods, respectively.

There are many product forecasting methods that may be used in combination, including, but not limited to: growth curves, diffusion models, mixed models, panel series models, smoothing models, neural networks, market response models, market share models, judgmental models, Bayesian methods, and combination methods. These models can be automatically selected based on a selection criterion such as MAPE, RMSE, AIC, and many others. Weighted combinations of the models based on the criterion are also possible. Additionally, the selection criterion can be based on in-sample or out-of-sample results or a weighted combination of the two. After the appropriate model specification is selected, the model can be fitted to the panel series data.

After selecting a new product forecasting model specification, the parameter vector, θ, is estimated using the surrogate panel series data as follows:

(ŷₗ,\hat{v}ₗ,ĉₗ,ĉₗ^{%},\hat{q}ₗ,\hat{Q})=\hat{F}({Zᵢ}ᵢ₌₁^{N},{\hat{z}ᵢ^{p}}ᵢ₌₁^{N}:\hat{θ})

where \hat{F}( ) represents the fitted model, Zᵢ represents the surrogate panel series matrix for the i^{th} dependent series, \vec{z}ᵢ^{p} surrogate panel properties vector for the i^{th} dependent series, \hat{θ} represents the parameter vector estimates, and (ŷₗ, \hat{v}ₗ, ĉₗ, ĉₗ^{%}, \hat{q}ₗ, \hat{Q}) represents the new product series predictions. The model parameter estimates, \hat{θ}, are typically optimized based on the data or provided by the user when little data is available. For a diffusion model example, the innovation and imitation parameters may be provided. Using these model parameter estimates, various model components estimates can be computed from the data. For a diffusion model example, the adoption component can be estimated. For a seasonal model example, the seasonal component can be estimated. Together, the model parameter and component estimates are called the fitted model. From the fitted model various statistical features can be extracted from the surrogate panel series that can be used to forecast the new product.

Typically, a new product forecasting method only generates predictions for either yₗ, cₗ, (rₗ,yₗ^{A}), (cₗ^{%},Q), or (qₗ,Q). All of the other predictions can be generated from the others using the following relationship:

yₗ=vₗyₗ^{A}=cₗ−cₗ₋₁=(cₗ^{%}−cₗ₋₁^{%})Q=qₗQ and when l=1, yₗ=cₗ=cₗ^{%}Q=qₗQ

Regardless of how the predictions were created, there are several ways in which predictions may be explored. These methods of exploring predictions include time series exploration, aggregate time series exploration, cycle series exploration, share series exploration, cumulative series exploration, cumulative percent series exploration, and profile series exploration.

With respect to time series exploration, for a given series index, i, a time series plot illustrates a single time series, y_{i,t}, with respect to the time index, tε{tᵢ^{b}, . . . , tᵢ^{e}}. Also, for a given series index, i, a time series plot illustrates a single share series, v_{i,t}, with respect to the time index, tε{tᵢ^{b}, . . . , tᵢ^{e}}. A cumulative series plot for a given series index, i, illustrates a single cumulative series, c_{i,t}, with respect to the time index, tε{tᵢ^{b}, . . . , tᵢ^{e}}. For a given series index, i, a cumulative percent series plot illustrates a single cumulative percent series, c_{i,t}^{%}, with respect to the time index, tε{tᵢ^{b}, . . . , tᵢ^{e}}, while a profile series plot illustrates a single profile series, q_{i,t}, with respect to the time index, tε{tᵢ^{b}, . . . , tᵢ^{e}}.

In cases where the system must illustrate multiple time series, vector series plotting may be used. For each series index, i, a vector series plot jointly illustrates several time series, y_{i,t}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} .$$

An example vector series plot is illustrated by FIG. 5A, where the vertical axis represents the dependent series values, y_{i,t}, and the horizontal axis represents the time index, t. Each plot line in FIG. 5A represents an individual series, i. For each series index, i, a share series vector plot jointly illustrates several share series, v_{i,t}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} .$$

A cumulative vector plot f or a each series index, i, jointly illustrates several cumulative series, c_{i,t}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} .$$

Further, a cumulative percent vector plot for each series index, i, jointly illustrates several cumulative percent series, c_{i,t}^{%}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} ,$$

and a profile vector plot for each series index, i, jointly illustrates several profile series, q_{i,t}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} .$$

Time series exploration may employ many different analyses and transformations. For example, possible time series analyses include cross series plots over time, autocorrelation plots, and cross-correlation plots. Meanwhile, possible time series transformations (either individually or jointly) include functional transformations, such as log, square-root, logistic, or Box-Cox, difference transformations, for example simple and seasonal differencing, and seasonal decomposition, including additive, multiplicative, pseudo-additive, or log-additive.

Aggregate time series exploration is facilitated by review of an aggregate time series plot, which illustrates the aggregation of all time series, yₜ^{A}, with respect to the time index,

$$t ∈ \{ \begin{matrix}min \\ i\end{matrix} ( {t}_{i}^{b} ) , … , \begin{matrix}max \\ i\end{matrix} ( {t}_{i}^{e} ) \} .$$

An example aggregate time series plot is illustrated by FIG. 5C, where the vertical axis represents the aggregate of dependent series values, yₜ^{A}, for example demand, and the horizontal axis represents the time index, t. Possible aggregate time series plots include series plots over time, cross series plots over time, autocorrelation plots, and cross-correlation plots. Further, potential aggregate time series transformations include functional transformations such as log, square-root, logistic, and Box-Cox, difference transformations, such as simple and seasonal differencing, and seasonal decomposition, for example additive, multiplicative, pseudo-additive, and log-additive.

Cycle series exploration may include generation of cycle series plots by the system. A cycle series plot for a given series index, i, illustrates a single cycle series, y_{i,l}, with respect to the cycle index, l=1, . . . , Lᵢ. Further, for a each series index, i, a cycle series panel plot jointly illustrates several cycle series, y_{i,l}, with respect to the cycle index, l=1, . . . , L^{P}. An example cycle series panel plot is illustrated in FIG. 5B. The vertical axis represents the dependent series values, y_{i,l}, and the horizontal axis represents the cycle index, l. Each plot line represents an individual series, i. Analyses that may be used during cycle series exploration include composite cycle (average or median profile), joint and individual diffusion analysis, joint and individual exponential decay analysis, and correlation between cycle and cumulative series.

Exploration of share series may include, for a given series index, i, a share series plot, which illustrates a single share series, v_{i,l}, with respect to the cycle index, l=1, . . . , Lᵢ. A share series panel plot for each series index, i, jointly illustrates several share series, v_{i,l}, with respect to the cycle index, l=1, . . . , L^{P}. An example share series panel plot is illustrated in FIG. 5D, where the vertical axis represents the share series values, v_{i,l}, and the horizontal axis represents the cycle index, l. Each plot line represents an individual series, i.

Cumulative series exploration may include the review of different graphical representations of cumulative series data. For a given series index, i, a cumulative series plot illustrates a single cumulative series, c_{i,l}, with respect to the cycle index, l=1, . . . , Lᵢ. Also, for each series index, i, a cumulative series panel plot jointly illustrates several cumulative series, c_{i,l}, with respect to the cycle index, l=1, . . . , L^{P}. An example cumulative series panel plot is illustrated in FIG. 5E, where the vertical axis represents the cumulative series values, c_{i,l}, and the horizontal axis represents the cycle index, l. Each plot line represents an individual series, i. As another example, for a each series index, i, a panel summary histogram jointly illustrates several cumulative demands, Qᵢ=c_{i,L}_{ᵢ}. The example panel summary histogram at 1100 in FIG. 11 illustrates this representation, and the bars in FIG. 11 represent the histogram, while the solid line represents a normal distribution with the same mean and variance.

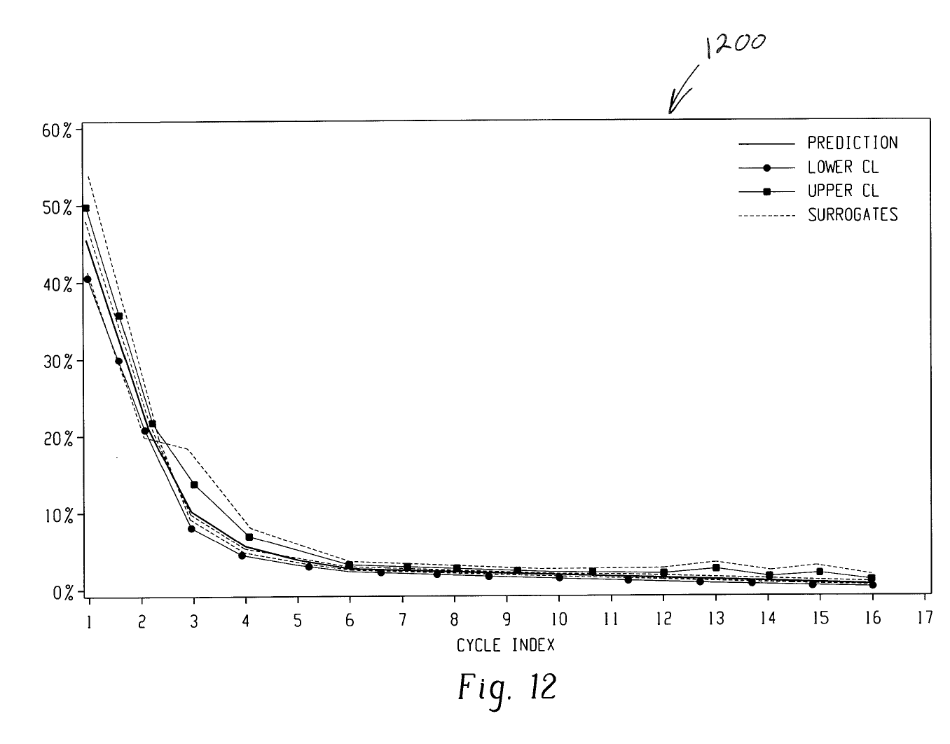

FIG. 12 provides another example of a model (used during the model step) generating predictions from data provided by the filter step. More specifically, FIG. 12 depicts at 1200 predictions for a new product forecast, wherein the dashed lines represent the surrogate series values, q_{i,l}. The solid unmarked line represents the prediction, \hat{q}ₗ, the line marked with circles its lower 95% confidence limit, and the line marked with squares its upper 95% confidence limit.

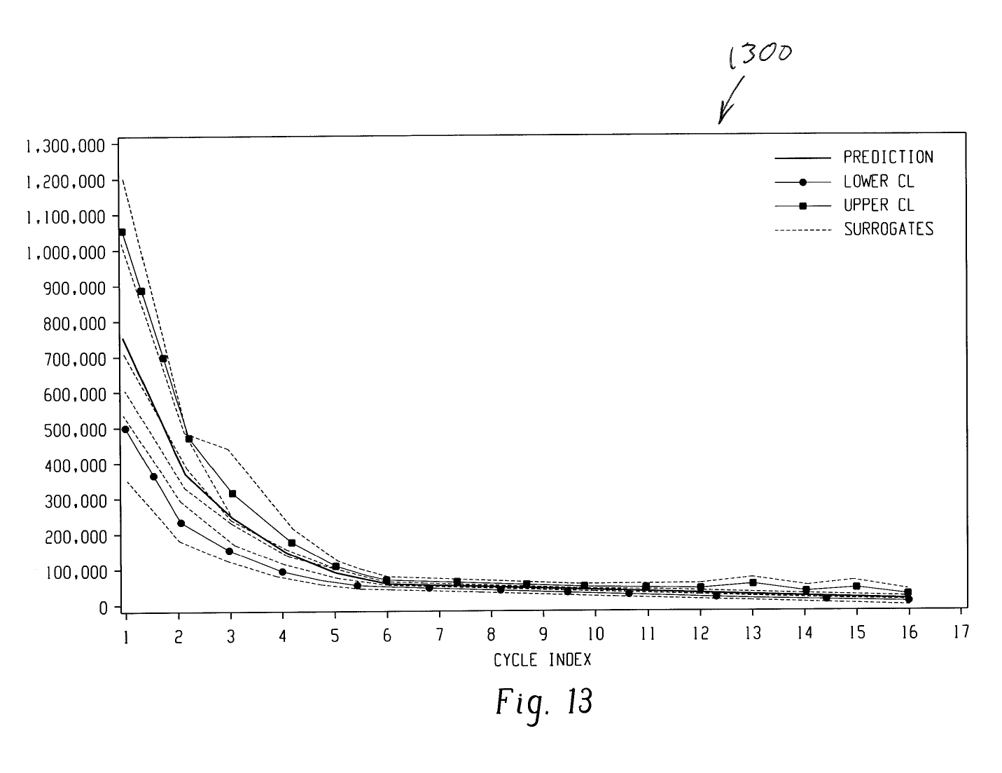

FIG. 13 depicts at 1300 yet another example of predictions for a new product forecast. The model for the cycle series, yₗ, could combine the simple averages of the panel summary and the profile series. The dashed lines represent the surrogate series values, Y_{i,l}. The solid unmarked line represents the prediction, ŷₗ, the line marked with circles its lower 95% confidence limit, and the line marked with squares its upper 95% confidence limit.

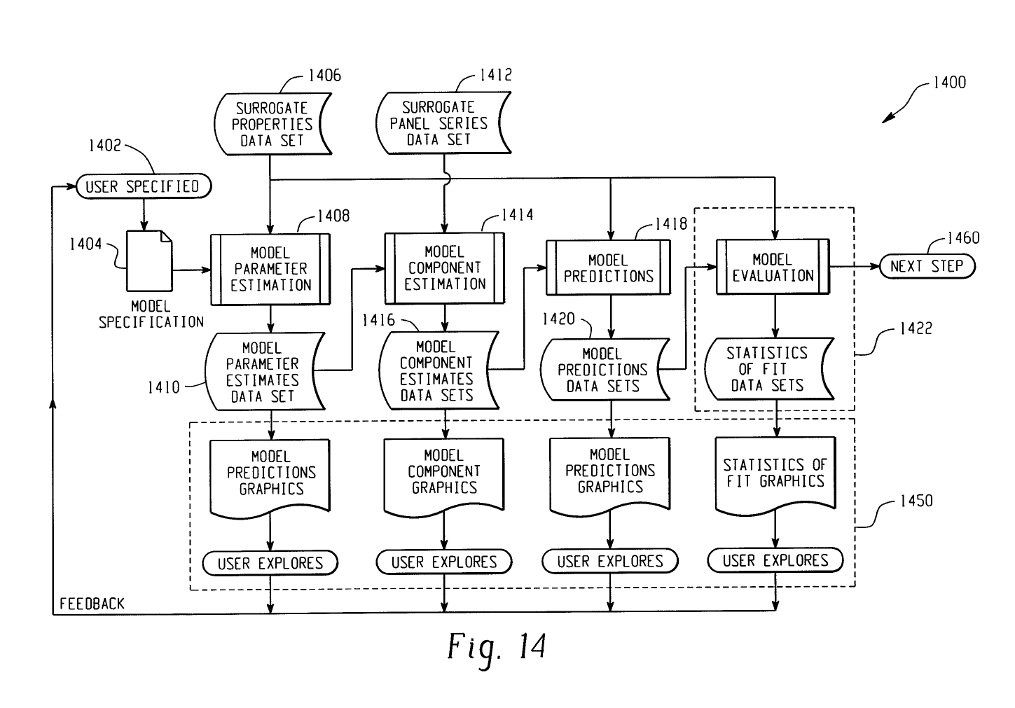

It should be understood that the model step can be implemented with many different types of operations, such as the detailed operations shown at 1400 in FIG. 14. With respect to FIG. 14, the user initially specifies at 1402 a model 1404:

(yₗ,vₗ,cₗ,cₗ^{%},qₗ,Q)=F({Zᵢ}ᵢ₌₁^{N},{\vec{z}ᵢ^{P}}ᵢ₌₁^{N}:θ)

Using the surrogate properties data 1406, the model parameters can be estimated or optimized at 1408 as symbolized by \hat{θ}. Using the model parameter estimates 1410 and the surrogate panel series data 1412, the model components can be estimated at 1414. Using the model component estimates 1416, the model predictions can be estimated at 1418 as follows:

(ŷₗ,\hat{v}ₗ,ĉₗ,ĉₗ^{%},\hat{q}ₗ,\hat{Q})=\hat{F}({Zᵢ}ᵢ₌₁^{N},{\vec{z}ᵢ^{P}}ᵢ₌₁^{N}:\hat{θ})

Using the model predictions 1420, the model can be evaluated at 1422 as follows: SOF(\vec{e},nₚ). In addition, as shown at 1450, after each sub-step described above, the user can graphically explore the results and modify the model specification. Additionally, the user can remove a surrogate series from further considerations that are deemed outliers based on the model results. The process then proceeds to the next step 1460.

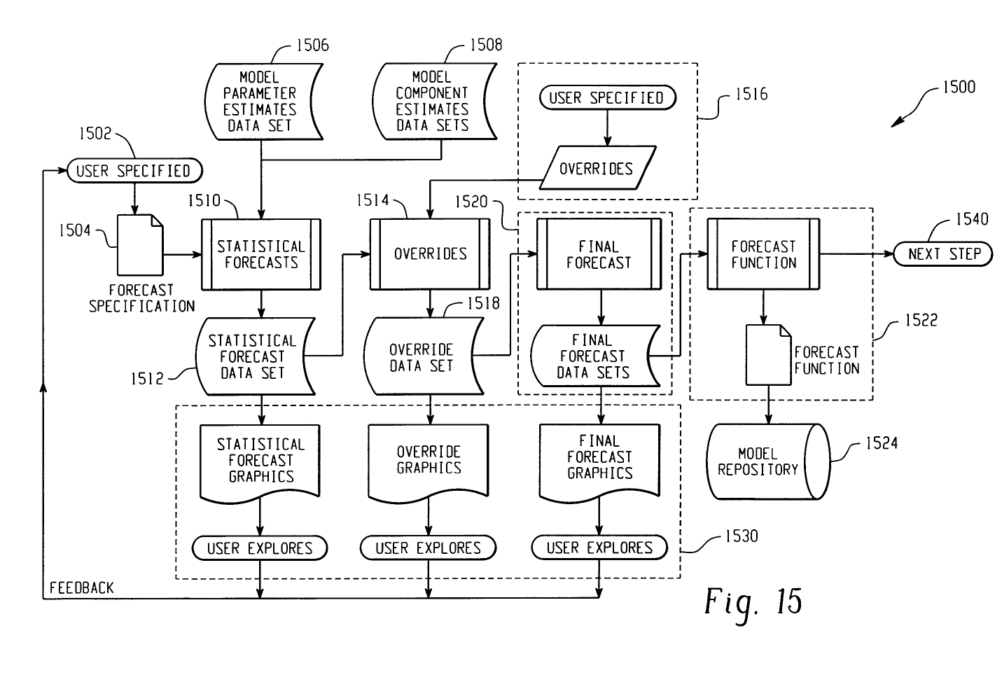

As discussed above, the new product forecasting system includes a forecast step. The forecast step can be configured in many different ways, such as in the manner depicted at 1500 in FIG. 15. In the forecasting operational scenario depicted in FIG. 15, the user specifies at 1502 the forecast specification 1504: tε{tᵢ^{b}, . . . , tᵢ^{e}}, which defines timing characteristics of the forecast. Using the model parameter estimates data set 1506 and model component estimates data set 1508, statistical forecasts 1510 are generated based on extracted features from the historical data. After viewing statistical forecasts 1512, the user can optionally apply judgmental overrides 1514, 1516. Combining the statistical forecasts 1512 and the overrides 1518, the final forecasts 1520 can be computed. A forecast function file 1522 is created and stored in a model repository 1524. In addition, as shown at 1530, after each sub-step described above, the user can graphically explore the results and modify the forecast specification. Additionally, the user can apply and remove overrides based on graphical feedback. The process then proceeds to next step 1540.

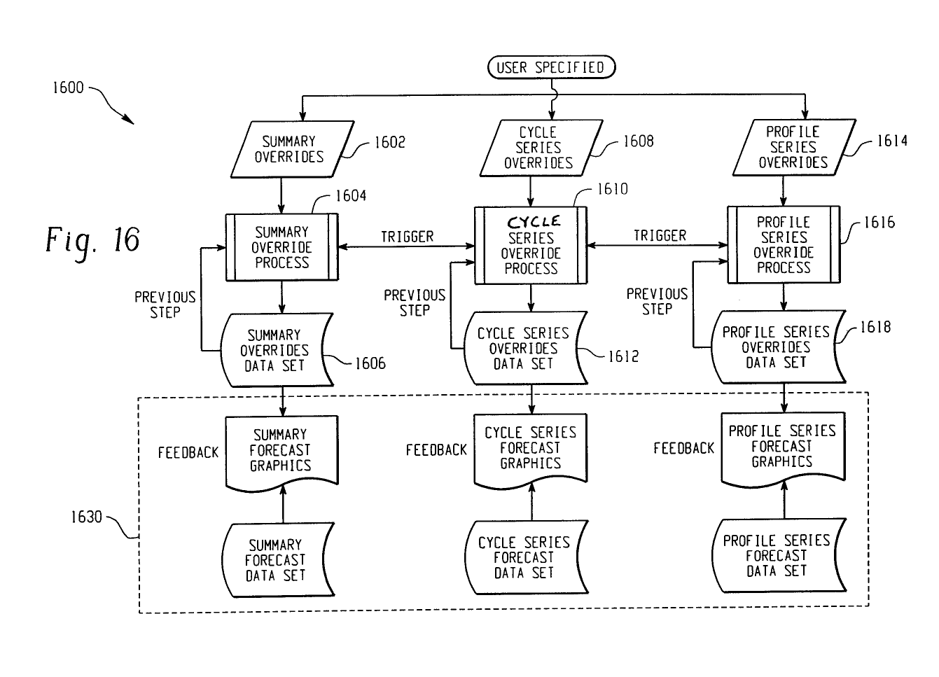

As depicted in FIG. 15, a user can employ overrides during the forecast step. The overrides can be implemented in many different ways, such as in the manner depicted at 1600 in FIG. 16. For example, summary (Q) forecast overrides can be accomplished by a user specifying summary overrides 1602, \hat{Q}^{J}, to the summary forecasts, \hat{Q}. The summary override data set 1606 is updated using the summary override process 1604. These overrides trigger changes in the cycle series overrides 1608, ŷₜ^{J}, because ŷₜ^{J}≈\hat{q}ₜ^{J}\hat{Q}^{J}. Using the summary override data set 1606 and the previous cycle series override data set, the cycle series override data set 1612 is updated using the cycle series override process 1610.

For profile series (qₜ) forecast overrides, the user specifies the profile series overrides 1614, \hat{q}ₜ^{J}, to the profile series forecasts, \hat{q}ₜ. These overrides trigger changes in the cycle series overrides 1608, ŷₜ^{J}. The profile series override data set 1618 is updated using the profile series override process 1616. These overrides trigger changes in the cycle series overrides, ŷₜ^{J}, because ŷₜ^{J}≈\hat{q}ₜ^{J}\hat{Q}^{J}. Using the profile series override data set 1618 and the previous cycle series override data set, the cycle series override data set 1612 is updated using the cycle series override process 1610.

For cycle series (yₜ=Qqₜ) forecast overrides, the user specifies the cycle series overrides 1608, ŷₜ^{J}, to the cycle series forecasts, ŷₜ. The cycle series override data set 1612 is updated using the cycle series override process 1610. These overrides trigger changes in both the summary, \hat{Q}^{J}, and profile series, \hat{q}ₜ^{J}, overrides because ŷₜ^{J}≈\hat{q}ₜ^{J}\hat{Q}^{J}. Using the cycle series override data set 1612 and the previous profile series override data set, the profile series override data set 1618 is updated using the profile series override process 1616. Also, using the cycle series override data set 1612 and the previous summary override data set, the summary override data set 1606 is updated using the summary override process 1604.

As shown at 1630, in each type of override, the user may graphically explore the forecast to determine the effect of the override(s). And based on the user's judgment, overrides may be added or removed.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting.

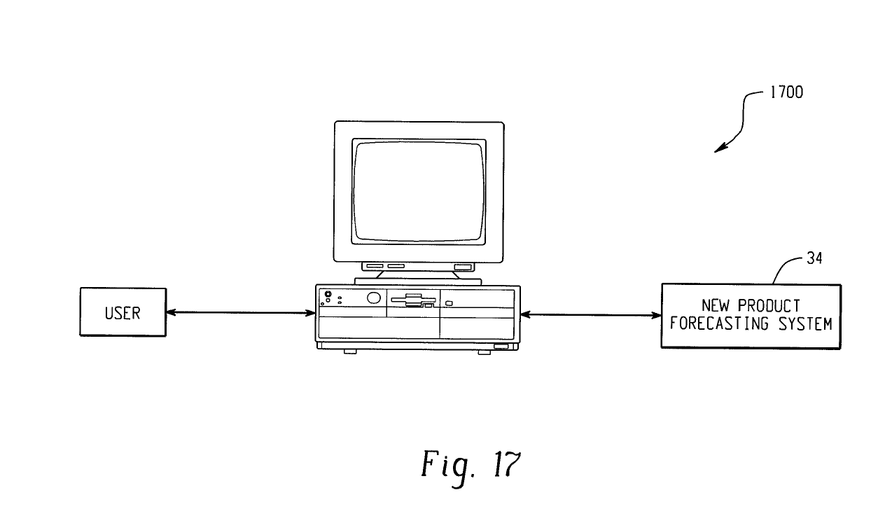

It is further noted that the systems and methods may be implemented on various types of computer architectures, such as for example on a single general purpose computer (as shown at 1700 on FIG. 17) or workstation, or on a networked system, or in a client-server configuration, or in an application service provider configuration.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for providing a new product forecast for performance of a product to be newly introduced in a market, the method comprising:
(a) querying a first group of historical products for which historical market performance series data and product attribute data are available in order to identify a first set of candidate series data from a subgroup of products, the members of which share one or more product attributes with the new product;
(b) filtering the first set of candidate series data to add to or remove from the first set of candidate series data historical market performance series data for one or more products, thereby resulting in a set of surrogate series data;
(c) extracting a set of statistical modeling features from the set of surrogate series data; and
(d) forecasting the performance of the new product using the set of statistical modeling features extracted from the set of surrogate series data;
wherein one or more graphical user interfaces are provided to:
(e) perform a specification sub-step wherein the specification sub-step facilitates an analyst specifying statistical analysis to be performed;
(f) perform an analysis sub-step wherein the analysis sub-step performs the specified statistical analysis and generates statistical analysis results;
(g) perform an exploration sub-step wherein the exploration sub-step facilitates the analyst visually exploring the statistical analysis results;
(h) perform a judgment sub-step wherein the judgment sub-step facilitates the analyst overriding the statistical analysis results with human judgment; and
(i) perform a feedback sub-step wherein the feedback sub-step facilitates the analyst's visual analysis of impact of the override;
wherein the one or more graphical user interfaces are used within said steps (a)-(d) to facilitate structured judgment analysis in analyzing the forecast for the new product;
wherein the new product forecast is provided to a user or an external system.

2. The method of claim 1, wherein step (a) further comprises:
in step (e), the analyst specifying the values or range of values for product attributes associated with the new product;
in step (f), the analyst querying the product attribute data for the first group of historical products that share one or more attributes with the new product;
in step (g), the analyst visually exploring the first set of candidate series data associated with the products sharing one or more attributes with the new product;
in step (h), the analyst removing one or more products or altering the values used in step (e) based on the visual exploration by the analyst of the first set of candidate series data; and
in step (i), the analyst visually exploring the revised first set of candidate series data.

3. The method of claim 2, wherein step (g) further comprises the analyst exploring how many surrogate series are included in the set of surrogate series data to ensure a sufficient sample is included.

4. The method of claim 1, wherein step (b) further comprises:
in step (e), the analyst choosing a statistical filter specification;
in step (f), the analyst:
computing properties of the candidate series data;
computing statistical distances between the candidate series; and
removing from the set of candidate series data those candidate series that are outliers with respect to the set of candidate series data and/or adding to the set of candidate series data historical market performance series data for products not chosen in step (a) that the analyst judges should be included, thereby forming the set of surrogate series data;
in step (g), the analyst visually exploring the set of surrogate series data; and
in step (h), the analyst removing one or more series from the set of surrogate series data or altering the statistical filter specification used in step (e) based on the visual exploration by the analyst of the set of surrogate series data; and
in step (i), the analyst visually exploring the revised set of surrogate series data.

5. The method of claim 4, wherein step (g) further comprises the analyst exploring how many surrogate series are included in the set of surrogate series data to ensure a sufficient sample is included.

6. The method of claim 1, wherein the candidate series data are clustered and step (b) comprises filtering a first set of clustered candidate series data to add or remove from the first set of candidate series data one or more clusters of candidate series data, thereby resulting in a set of surrogate series data.

7. The method of claim 1, wherein step (c) further comprises:
in step (e), the analyst choosing a statistical model specification;
in step (f), the analyst:
fitting the statistical model specification to the set of surrogate series data;
extracting a set of statistical modeling features based on the statistical model specification;
computing pooled predictions for the set of surrogate series using the set of statistical modeling features; and
computing prediction errors for each of the surrogate series based on the pooled predictions;
in step (g), the analyst visually exploring the set of surrogate series data, the pooled predictions, and model results for each of the surrogate series;
in step (h), the analyst removing one or more series from the set of surrogate series data or altering the statistical model specification used in step (e) based on the visual exploration by the analyst of the set of surrogate series data; and
in step (i), the analyst visually exploring the revised set of surrogate series data and/or statistical modeling results.

8. The method of claim 4, wherein step (e) is performed automatically according to one or more model selection criteria.

9. The method of claim 1, wherein step (d) further comprises:
in step (e), the analyst choosing a forecast specification describing timing of the new product;
in step (f), the analyst compensating for timing considerations in model forecasts for the new product;
in step (g), the analyst visually exploring statistical forecasts for the new product;
in step (h), the analyst overriding one or more of the statistical forecasts for the new product based on the visual exploration by the analyst of the statistical forecasts for the new product; and
in step (i), the analyst visually exploring the statistical forecasts and any overrides based on the analyst's judgment.

10. The method of claim 1, wherein the market performance data comprises panel series data.

11. The method of claim 1, wherein a batching mechanism is provided in order to:
(j) query a second group of historical products for which historical market performance series data and product attribute data are available in order to identify a second set of candidate series data from a subgroup of products the members of which share one or more product attributes with the new product;
(k) filter the second set of candidate series data to remove, from the second set of candidate series data, products whose candidate series data are outliers with respect to the set of candidate series data, thereby resulting in a set of surrogate series data;
(l) extract a set of statistical modeling features from the set of surrogate series data; and
(m) forecast the performance of the new product using the set of statistical modeling features extracted from the set of surrogate series data.

12. The method of claim 11, wherein computer-executable instructions are generated for performing one or more of steps (a)-(m) and encompassing the decisions made by the analyst in a previous instance of the analyst performing the one or more steps.

13. The method of claim 1, wherein a computer-implemented wizard is used to perform the method steps, the computer-implemented wizard comprising:
a back operation in order to access a previous step for facilitating modification of data with respect to the previous step;
a next operation in order to examine effect of the modification of the data on one or more succeeding steps; and
a reset operation in order to permit any changes made during one or more of the method steps to be undone and values in the new product forecast to be restored to their initial generated state.

14. The method of claim 1, wherein one or more steps are automated to run without intervention of an analyst.

15. The method of claim 14, wherein exception criteria are defined that permit members of the set of candidate series data to be analyzed further.

16. The method of claim 1, wherein the one or more graphical user interfaces provide one or more views of the new product forecast chosen from the group: a shape view, a total sales view, and a combined view.

17. A computer-implemented system for providing a new product forecast for performance of a product to be newly introduced in a market, said system comprising:
software instructions configured to operate on a processor for querying a first group of historical products for which historical market performance series data and product attribute data are available in order to identify a first set of candidate series data from a subgroup of products, the members of which share one or more product attributes with the new product;
software instructions configured to operate on a processor for filtering the first set of candidate series data to add to or remove from the first set of candidate series data historical market performance series data for one or more products, thereby resulting in a set of surrogate series data;
software instructions configured to operate on a processor for extracting a set of statistical modeling features from the set of surrogate series data; and
software instructions configured to operate on a processor for forecasting the performance of the new product using the set of statistical modeling features extracted from the set of surrogate series data;
one or more graphical user interfaces configured to:
perform a specification sub-step wherein the specification sub-step facilitates an analyst specifying statistical analysis to be performed;
perform an analysis sub-step wherein the analysis sub-step performs the specified statistical analysis and generates statistical analysis results;
perform an exploration sub-step wherein the exploration sub-step facilitates the analyst visually exploring the statistical analysis results;
perform a judgment sub-step wherein the judgment sub-step facilitates the analyst overriding the statistical analysis results with human judgment; and
perform a feedback sub-step wherein the feedback sub-step facilitates the analyst's visual analysis of impact of the override;
wherein the one or more graphical user interfaces are used to facilitate structured judgment analysis in analyzing the forecast for the new product;
wherein the new product forecast is provided to a user or an external system.
